(19) United States
(12) Patent Application Publication
(10) Pub. No.: US 2025/0131129 A1
(43) Pub. Date: Apr. 24, 2025

(54) ELECTRONIC DEVICE, METHOD, AND RECORDING MEDIUM FOR SUPPORTING ARTIFICIAL INTELLIGENCE-BASED DATA SHARING

(71) Applicant: Samsung Electronics Co., Ltd., Suwon-si (KR)

(72) Inventors: Yoechan SONG, Suwon-si (KR); Dukhyun KIM, Suwon-si (KR); Sangheon KIM, Suwon-si (KR); Junsung KIM, Suwon-si (KR); Dongil SON, Suwon-si (KR); Yeunwook LIM, Suwon-si (KR)

(21) Appl. No.: 18/939,928

(22) Filed: Nov. 7, 2024

Related U.S. Application Data
(63) Continuation of application No. PCT/KR2024/016249, filed on Oct. 24, 2024.

(30) Foreign Application Priority Data
Oct. 24, 2023 (KR) 10-2023-0143068
Dec. 27, 2023 (KR) 10-2023-0192711

(51) Int. Cl. G06F 21/62

(52) U.S. Cl. CPC G06F 21/6254

(57) ABSTRACT

Various embodiments of the disclosure provide an electronic device, a method, and a recording medium configured to provide data sharing based on artificial intelligence (AI). The electronic device according to an embodiment may analyze shared data selected based on an input requesting to shared data of the electronic device. The electronic device may, based on the shared data including the personal information, generate hint information related to the personal information so that information corresponding to the personal information may be inferred by an external electronic device. The electronic device may replace the personal information with the hint information in the shared data and share the shared data including the hint information.

### CROSS-REFERENCE TO RELATED APPLICATIONS

This application is a continuation of International Application No. PCT/KR2024/016249 designating the United States, filed on Oct. 24, 2024, in the Korean Intellectual Property Receiving Office and claiming priority to Korean Patent Application Nos. 10-2023-0143068, filed on Oct. 24, 2023, and 10-2023-0192711, filed on Dec. 27, 2023, in the Korean Intellectual Property Office, the disclosures of each of which are incorporated by reference herein in their entireties.

### BACKGROUND

### Field

The disclosure relates to an electronic device, a method, and a recording medium configured to share data between electronic devices based on artificial intelligence (AI).

### Description of Related Art

In accordance with development of digital technologies, various types of electronic devices, such as a smartphone, a digital camera, and/or a wearable device have become widely used. The electronic devices have been continuously improved in terms of hardware and/or software of the electronic devices to support and increase functions thereof.

For example, a portable electronic device (hereinafter, an electronic device) represented by a smartphone may be equipped with a variety of functions. The electronic device may include a touchscreen-based display to allow a user to easily access various functions and provide various application screens through the display.

Recently, big data and deep learning technologies has been rapidly advanced to enable the implementation of AI technologies in electronic devices and has been applied to personal services that integrally provide and utilize analysis of specific data and information in various fields specialized for users. For example, a user may control an electronic device in a conversational way through voice and may search for specific information and ask questions and respond through a knowledge base using deep learning.

Meanwhile, the electronic device may provide a function for sharing data with another electronic device. The electronic device may share data by transmitting data selected by the user to another electronic device through designated communication. The data shared by the electronic device may include sensitive information, such as personal information (or personal data) relating to an individual user. However, the electronic device may share data including personal information regardless of whether or not the data include personal information, unintentionally causing the personal information of the user to be exposed to the outside (e.g., another person).

Therefore, in case that data includes personal information when the data is shared, the user may experience inconvenience that the user needs to manually remove or edit a personal information portion before sharing the data. Furthermore, a user having received the data from which personal information has been edited or removed may experience inconvenience that the user needs to manually add personal information to the portion corresponding to the personal information in shared data.

The above-described information may be provided as related art for the purpose of assisting in understanding the disclosure. No assertion is made as to whether any of the above might be applicable as prior art with regard to the disclosure.

### SUMMARY

Embodiments of the disclosure provide a method for causing personal information to be automatically removed and replaced with hint information when data is shared between electronic devices, and an electronic device and a recording medium supporting same.

Embodiments of the disclosure provide a method for generating personal information based on the hint information included in the shared data and generating data based on the personal information when data is shared between electronic devices, and an electronic device and a recording medium supporting same.

Embodiments of the disclosure provide a method for analyzing personal information or hint information from at least one piece of information of shared data and performing replacing between information based on an analysis result so as to configure user-specific data, and an electronic device and a recording medium supporting same.

An electronic device according to an example embodiment may include: a display, a memory configured to store instructions (or commands), and at least one processor including processing circuitry. In an embodiment, the memory may store instructions, wherein at least one processor, individually and/or collectively, is configured to execute the instructions and to cause the electronic device to perform an operation.

According to an example embodiment, at least one processor, individually and/or collectively, is configured to cause the electronic device to: receive an input requesting to share data of the electronic device; analyze shared data selected based on the input; determine whether the shared data includes personal information associated with a user of the electronic device; based on the shared data including the personal information, generate hint information related to the personal information so that information corresponding to the personal information may be inferred by an external electronic device; replace the personal information with the hint information in the shared data; and share the shared data including the hint information.

A method of operating an electronic device according to an example embodiment of the disclosure may include: receiving an input requesting sharing data of the electronic device; analyzing shared data selected based on the input; determining whether the shared data includes personal information related to a user of the electronic device; based on the shared data including the personal information, generating hint information related to the personal information so that information corresponding to the personal information may be inferred by an external electronic device; replacing the personal information with the hint information in the shared data; and sharing the shared data including the hint information.

In order to address the problems described above, various example embodiments of the disclosure may include a non-transitory computer-readable recording medium on which a program configured to execute the method on a processor is recorded.

According to an example embodiment, a non-transitory computer-readable recording medium (or storing medium or computer program product) configured to store one or more programs may be provided. According to an example embodiment, the one or more programs may include commands (or instructions) to perform operations including: receiving an input requesting sharing data of an electronic device, analyzing shared data selected based on the input, determining whether the shared data includes personal information related to a user of the electronic device, based on the shared data including the personal information, generating hint information related to the personal information so that information corresponding to the personal information may be inferred by an external electronic device, replacing the personal information with the hint information in the shared data, and sharing the shared data including the hint information.

The additional range of applicability of the disclosure will become apparent to one skilled in the art from the following detailed description. However, since various modifications and alternatives within the spirit and scope of the disclosure may be clearly understood by those skilled in the art, it is to be understood that a detailed description and various example embodiments of the disclosure are provided by way of example.

The electronic device, the operation method, and the recording medium according to an example embodiment of the disclosure, when data is shared between electronic devices, personal information is automatically removed and replaced with hint information and then the data is shared, preventing and/or reducing external exposure of the user's personal information. According to an example embodiment of the disclosure, when the data is shared between electronic devices, personal information is automatically generated based on hint information included in data shared and data is provided based on the personal information, providing convenience in configuring user's data. According to an example embodiment of the disclosure, user-specific data may be provided through substituting between personal information or hint information in shared data. According to an example embodiment, the user's needs for using electronic devices are satisfied and new user experience (UX) according to the use of electronic devices may be provided.

Various other effects understood directly or indirectly through the disclosure may be provided. Advantageous effects obtainable from the disclosure may not be limited to the above-mentioned effects, and other effects which are not mentioned may be clearly understood from the following descriptions by those skilled in the art to which the disclosure pertains.

### BRIEF DESCRIPTION OF THE DRAWINGS

With regard to the description of the drawings, the same or like reference signs may be used to designate the same or like elements. Further, the above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a block diagram illustrating an example configuration of an integrated intelligence system according to various embodiments;

FIG. 3 is a diagram illustrating an example format of storing relationship information between concept and action in a database according to various embodiments;

FIG. 4 is a block diagram illustrating an example configuration of an electronic device according to various embodiments;

FIG. 5 is a flowchart illustrating an example method of operating an electronic device according to various embodiments;

FIG. 6 is a flowchart illustrating an example method of operating an electronic device according to various embodiments;

FIG. 7 is a flowchart illustrating an example method of operating an electronic device according to various embodiments;

FIG. 8 is a signal flow diagram illustrating an example operation of providing a routine-related operation between electronic devices according to various embodiments;

FIG. 9 is a diagram illustrating an example operation of providing a routine-related operation between electronic devices according to various embodiments;

FIG. 10 is a block diagram illustrating an example configuration of an electronic device configured to support a routine-related operation according to various embodiments;

FIG. 11 is a signal flow diagram illustrating an example operation of sharing routine data in an electronic device according to various embodiments;

FIG. 12 is a signal flow diagram illustrating an example operation of configuring a routine based on routine data shared by an electronic device according to various embodiments;

FIG. 13 is a diagram illustrating an example operation of generating personal information-based hint information in an electronic device according to various embodiments;

FIG. 14 is a diagram illustrating an example operation of generating hint information-based personal information in an electronic device according to various embodiments;

FIG. 15 is a flowchart illustrating an example method of operating an electronic device according to various embodiments;

FIG. 16 is a diagram illustrating an example operation of providing a routine-related operation in an electronic device according to various embodiments;

FIG. 17 is a flowchart illustrating an example method of operating an electronic device according to various embodiments; and

FIG. 18 is a flowchart illustrating an example method of operating an electronic device according to various embodiments.

### DETAILED DESCRIPTION

Hereinafter, various example embodiments of the disclosure will be described in greater detail with reference to the drawings. However, the disclosure may be implemented in various forms and is not limited to the various embodiments set forth herein. With regard to the description of the drawings, the same or like reference signs may be used to designate the same or like elements. Also, in the drawings and the relevant descriptions, description of well-known functions and configurations may be omitted for the sake of clarity and brevity.

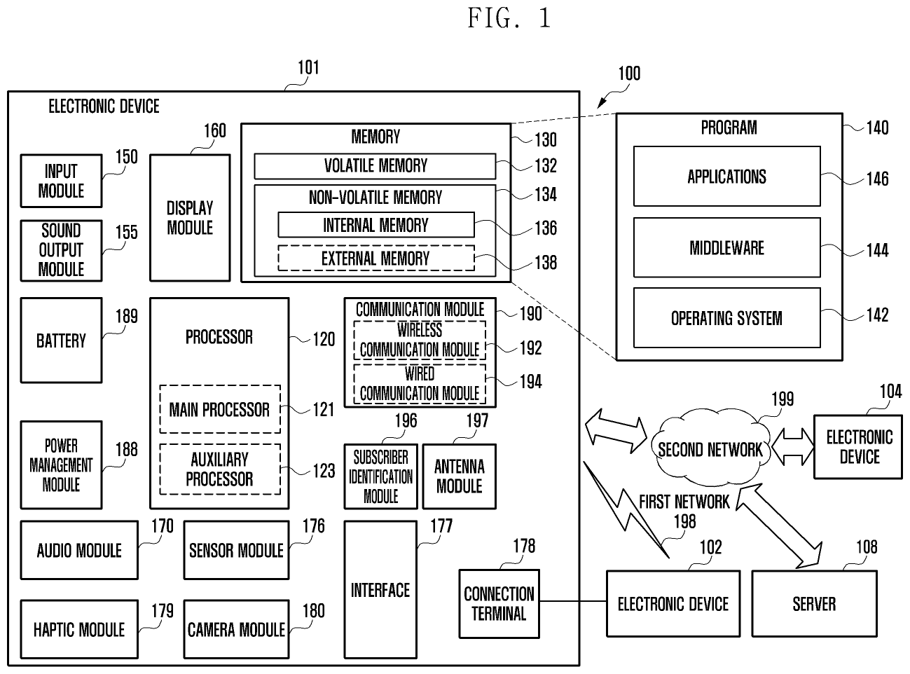

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

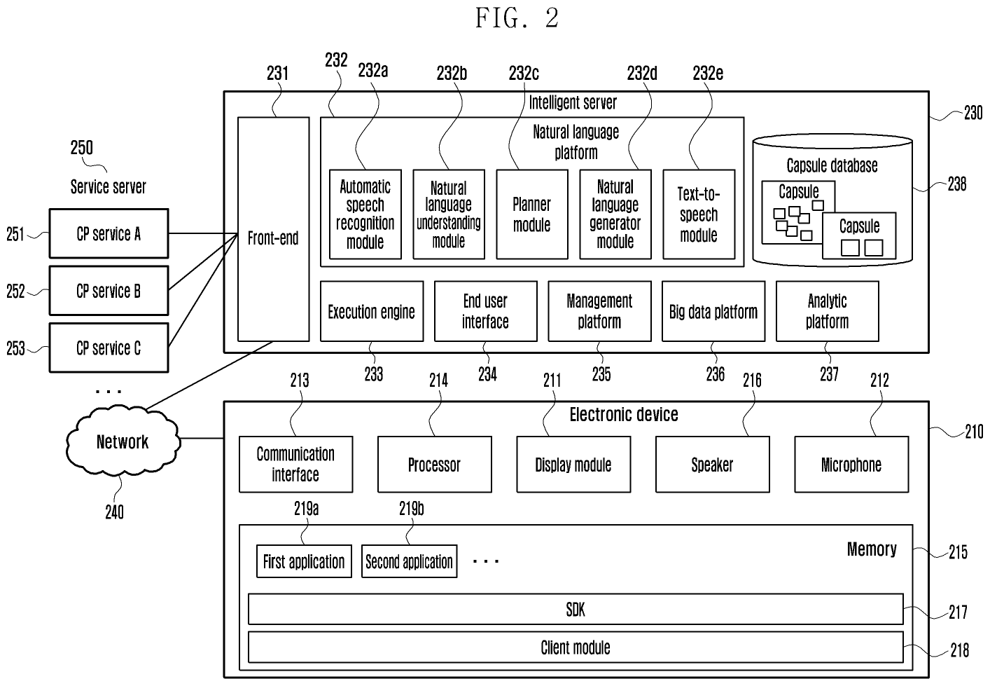

FIG. 2 is a block diagram illustrating an example configuration of an integrated intelligence system according to various embodiments.

Referring to FIG. 2, the integrated intelligence system may include an electronic device 210 (e.g., the electronic device 101 in FIG. 1), an intelligent server 230 (e.g., the server 108 in FIG. 1), and a service server 250 (e.g., the server 108 in FIG. 1).

According to an embodiment, the electronic device 210 may correspond to a terminal device (or an electronic device) connectible to the Internet and may include a cell phone, a smartphone, a personal digital assistant (PDA), a laptop computer, a TV, a domestic appliance, a wearable device, a head mounted display (HMD), or a smart speaker.

According to a described embodiment, the electronic device 210 may include a communication interface (e.g., including communication circuitry) 213 (e.g., the interface 177 in FIG. 1), a microphone 212 (the input module 150 in FIG. 1), a speaker 216 (e.g., the audio output module 155 in FIG. 1), a display module (e.g., including a display) 211 (e.g., the display module 160 in FIG. 1), a memory 215 (e.g., the memory 130 in FIG. 1), and/or a processor (e.g., including processing circuitry) 214 (e.g., the processor 120 in FIG. 1). The components enumerated above may be operatively or electrically connected to each other. The electronic device 210 may include at least a portion of the structure and/or function of the electronic device 101 in FIG. 1.

According to an embodiment, the communication interface 213 may include various communication circuitry and be configured to be connected to an external device to transmit or receive data. According to an embodiment, the microphone 212 may receive sound (e.g., a user utterance) and convert the sound into an electrical signal. According to an embodiment, the speaker 216 may output an electrical signal as sound (e.g., a voice).

According to an embodiment, the display module 211 may include at least one display and be configured to display an image or a video. According to an embodiment, the display module 211 may display a graphic user inter interface (GUI) of an executed application (app) (or an application program). The display module 211 of an embodiment may receive a touch input through a touch sensor. For example, the display module 211 may receive a text input through a touch sensor of an on-screen keyboard displayed within the display module 211.

According to an embodiment, the memory 215 may store a client module 218, a software development kit (SDK) 217 and multiple applications (e.g., a first application 219a and a second application 219b). The client module 218 and the SDK 217 may configure a framework (or a solution program) to perform general-purpose functions. Furthermore, the client module 218 or the SDK 217 may configure a framework configured to process a user input (e.g., a voice input, a text input, and a touch input).

According to an embodiment, the multiple applications 219a and 219b stored in the memory 215 may correspond to programs configured to perform a designated function. According to an embodiment, the multiple application may include a first application 219a and a second application 219b. According to an embodiment, each of the multiple applications 219a and 219b may include multiple operations configured to perform a designated function. For example, the applications 219a and 219b may include an alarm application, a message application, and/or a schedule application. According to an embodiment, the multiple applications 219a and 219b may be executed by the processor 214 and consecutively perform at least a portion of the multiple operations.

According to an embodiment, the processor 214 may include various processing circuitry and control overall operations of the electronic device 210. For example, the processor 214 may be electrically connected to the communication interface 213, the microphone 212, the speaker 216, and the display module 211 to perform a designated operation. The processor 214 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the processor 214 may execute a program stored the memory 215 to perform a designated function. For example, the processor 214 may execute at least one of the client module 218 or the SDK 217 to perform operations below to process a user input. For example, the processor 214 may control operations of the multiple applications 219a and 219b through the SDK 217. Operations of the client module 218 or the SDK 217 described below may correspond to operations performed by execution of the processor 214.

According to an embodiment, the client module 218 may receive an input (e.g., a user input). For example, the client module 218 may receive a voice signal corresponding to a user's utterance detected through the microphone 212. Alternatively, the client module 218 may receive a touch input detected through the display module 211. The client module 218 may receive a text input detected through a keyboard or an on-screen keyboard. In addition, various types of user inputs detected through an input module included in the electronic device 210 or an input module connected to the electronic device 210 may be received. The client module 218 may transmit the received user input to the intelligent server 230. The client module 218 may transmit state information of the electronic device 210, together with the received user input, to the intelligent server 230. The state information may correspond to, for example, execution state information of an application.

According to an embodiment, the client module 218 may receive a result corresponding to the received user input. For example, the client module 218 may receive a result corresponding to the received user input in case that the intelligent server 230 is capable of calculating a result corresponding to the received user input. The client module 218 may display the received result on the display module 211. Alternatively, the client module 218 may output the received result as audio through the speaker 216.

According to an embodiment, the client module 218 may receive a plan corresponding to the received user input. The client module 218 may display, on the display module 211, a result acquired by executing multiple operations of an application according to the plan. For example, the client module 218 may consecutively display execution results acquired by performing multiple operations on the display module 211 and output the execution results as audio through the speaker 216. For another example, the electronic device 210 may display partial execution results acquired by performing multiple operations (e.g., a result of a last operation) on the display module 211 and output the execution results as audio through the speaker 216.

According to an embodiment, the client module 218 may receive a request configured to acquire information required for calculating a result corresponding to a voice input from the intelligent server 230. According to an embodiment, the client module 218 may transmit the required information to the intelligent server 230 in response to the request.

According to an embodiment, the client module 218 may transmit, to the intelligent server 230, result information acquired by performing multiple operations according to the plan. The intelligent server 230 may identify that the received user input is correctly processed, using the result information.

According to an embodiment, the client module 218 may include a voice recognition module. According to an embodiment, the client module 218 may recognize a voice input to perform limited function through the voice recognition module. For example, the client module 218 may perform an intelligent application to process the voice input configured to systematically perform an operation through a designated input (e.g., Wake up!).

According to an embodiment, the intelligent server 230 may receive information related to a user voice input from the electronic device 210 through a communications network. According to an embodiment, the intelligent server 230 may change data related to the received voice input into text data. According to an embodiment, the intelligent server 230 may generate a plan to perform a task corresponding to the user voice input, based on the text data.

According to an embodiment, the plan may be generated by an artificial intelligence (AI) system. The artificial intelligence system may correspond to a rule-based system or a neural network-based system (NNS) (e.g., a feedforward neural network (FNN)), a recurrent neural network (RNN), or the like. The artificial intelligence system may include a combination of the above or another artificial intelligence system. According to an embodiment, the plan may be selected from a set of predefined plans or generated in real time in response to a request of the user. For example, the artificial intelligence system may select at least one plan among predefined multiple plans.

According to an embodiment, the intelligent server 230 may transmit a result according to the generated plan to the electronic device 210 or transmit the generated plan to the electronic device (210). According to an embodiment, the electronic device 210 may display, on the display module 211, the result according to the plan. According to an embodiment, the electronic device 210 may display, on the display module 211, the result acquired by performing an operation according to the plan.

According to an embodiment, the intelligent server 230 may include a front end 231, a natural language platform 232, a capsule database (DB) 238, an execution engine 233, an end user interface 234, a management platform 235, a big data platform 236, and/or an analytic platform 237.

According to an embodiment, the front end 231 may receive a user input from the electronic device 210. The front end 231 may transmit a response corresponding to the user input.

According to an embodiment, the natural language platform 232 may include an automatic speech recognition module (ASR module) 232a, a natural language understanding module (NLU module) 232b, a planner module 232c, a natural language generator module (NLG module) 232d, and/or a text-to-speech module (TTS module) 232e.

According to an embodiment, the automatic speech recognition module 232a may convert a voice input received from the electronic device 210 into text data. According to an embodiment, the natural language understanding module 232b may use text data of a voice input to understand an intent of the user. For example, the natural language understanding module 232b may perform syntactic analyze and/or semantic analyze with respect to the user input in a form of text data to understand an intent of the user. According to an embodiment, the natural language understanding module 232b may use linguistic features of a morpheme or phrase (e.g., grammatical elements), understand a meaning of a word extracted from the voice input, match a meaning of the understood word to an intent so as to determine the intent of the user. The natural language understanding module 232b may acquire intent information corresponding to a user utterance. The intent information may correspond to information indicating an intent of the user, which may be determined by analyzing text data. The intent information may include information indicating an operation or function to be executed by the user using a device.

According to an embodiment, the planner module 232c may generate a plan using a parameter or intent determined in the natural language understanding module 232b. According to an embodiment, the planner module 232c may determine multiple domains required for performing a task based on the determined intent. The planner module 232c may determine multiple operations included in each of the multiple domains determined based on the intent. According to an embodiment, the planner module 232c may determine a parameter required for performing the multiple operations or a result value output according to the performing of the multiple operations. The parameter and the result value may be defined as a concept of a designated type (or class). Accordingly, the plan may include the multiple operations determined by the intent of the user and multiple concepts.

According to an embodiment, the planner module 232c may determine a relationship between the multiple operations and the multiple concepts in a stepwise (or hierarchical) manner. For example, the planner module 232c may determine, based on the multiple concepts, an execution order of the multiple operations determined based on the intent of the user. In other words, the planner module 232c may determine an execution order of the multiple operations, based on a parameter required for the performing of the multiple operations and a result to be output by the performing of the multiple operations. Accordingly, the planner module 232c may generate a plan including association information (e.g., ontology) between the multiple operations and the multiple concepts. The planner module 232c may generate a plan using information stored in the capsule database 238 in which a set of relationships of the concepts and the operations is stored.

According to an embodiment, the natural language generator module 232d may change designated information into a text form. The information changed to have a text form may be in a form of natural language utterance. According to an embodiment, the text-to-speech module 232e may change the information in the text form to information in an audio form.

According to an embodiment, a portion or the entirety of the functions of the natural language platform 232 may be realized in the electronic device 210.

The capsule database 238 may store information for the relationship of the multiple concepts and operations corresponding to multiple domains. A capsule according to an embodiment may include multiple operation objects (action objects or operation information) and concept objects (or concept information) included in the plan. According to an embodiment, the capsule database 238 may store multiple capsules in a concept action network (CAN) form. According to an embodiment, the multiple capsules may be stored in a function registry included in the capsule database 238.

The capsule database 238 may include a strategy registry which stores strategy information required when a plan corresponding to the user input is determined. In case that there are multiple plans corresponding to a user input, the strategy registry may include reference information for determining one plan. According to an embodiment, the capsule database 238 may include a follow-up registry which stores information of a follow-up operation configured to suggest the follow-up operation to the user in a designated situation. The follow-up operation may include, for example, a follow-up utterance. According to an embodiment, the capsule database 238 may include a layout registry which stores layout information of information to be output through the electronic device 210. According to an embodiment, the capsule database 238 may include a vocabulary registry which stores vocabulary information included in capsule information. According to an embodiment, the capsule database 238 may include a dialog registry which stores information on a dialog (or interaction) with the user. The capsule database 238 may update an object stored through a developer tool. The developer tool may include, for example, a function editor configured to update an operation object or concept object. The developer tool may include a vocabulary editor configured to update a vocabulary. The developer tool may include a strategy editor configured to generate and register a strategy configured to determine a plan. The developer tool may include a dialog editor configured to generate a dialog with the user. The developer tool may include a follow-up editor which may allow editing of a follow-up utterance for activating a follow-up target and providing a hint. The follow-up target may be determined based on a currently configured target, a user preference, or an environmental condition. In an embodiment, the capsule database 238 may be realized in the electronic device 210.

According to an embodiment, the execution engine 233 may calculate a result using the generated plan. The end user interface 234 may transmit the calculated result to the electronic device 210. Accordingly, the electronic device 210 may receive the result and provide the received result to the user. According to an embodiment, the management platform 235 may manage information used in the intelligent server 230. According to an embodiment, the big data platform 236 may collect data of the user. According to an embodiment, the analytic platform 237 may manage quality of service (QoS) of the intelligent server 230. For example, the analytic platform 237 may manage components and processing speed (or efficiency) of the intelligent server 230.

According to an embodiment, the service server 250 may provide a designated service (e.g., ordering food or making a hotel reservation) to the electronic device 210. According to an embodiment, the service server 250 may correspond to a server operated by a third party. According to an embodiment, the service server 250 may provide, to the intelligent server 230, information for generating a plan corresponding to the received voice input. The provided information may be stored in the capsule database 238. In addition, the service server 250 may provide, to the intelligent server 230, result information according to the plan. The service server 250 may include multiple service providers (e.g., CP service A 251, CP service B 252, and CP service C 253) and each service provider 251, 252, or 253 may provide a function for a domain related to each capsule stored in the capsule database 238 of the intelligent server 230.

In the integrated intelligence system described above, the electronic device 210 may provide various intelligent services to the user in response to the user input. The user input may include, for example, an input through a physical button, a touch input, or a voice input.

According to an embodiment, the electronic device 210 may provide a voice recognition service through an intelligent application (or a voice recognition application). In this case, for example, the electronic device 210 may recognize a user utterance or a voice input received through the microphone 212 and provide a service corresponding to the recognized voice input to the user.

According to an embodiment, based on the received voice input, the electronic device 210 may perform a designated operation independently or in conjunction with the intelligent server 230 and/or the service server 250. For example, the electronic device 210 may execute an application corresponding to the received voice input and perform a designated operation through the executed application.

According to an embodiment, in case that the electronic device 210 provides the service in conjunction with the intelligent server 230 and/or the service server 250, the electronic device 210 may detect a user utterance using the microphone 212 and generate a signal (or voice data) corresponding to the detected user utterance. The electronic device 210 may transmit the voice data to the intelligent server 230 using the communication interface 213 through the network 240.

As a response to the voice input received from the electronic device 210, the intelligent server 230 according to an embodiment may generate a plan to perform a task corresponding to the voice input or a result acquired by performing an operation according to the plan. The plan may include, for example, multiple operations to perform the task corresponding to the voice input of the user and multiple concepts related to the multiple operations. The concepts may be acquired by defining a parameter input according to the execution of the multiple operations or a result value output according to the execution of the multiple operations. The plan may include association information between the multiple operations and the multiple concepts.

According to an embodiment, the electronic device 210 may receive the response using the communication interface 213. The electronic device 210 may output, to the outside, a voice signal generated inside the electronic device 210 using the speaker 216 or output an image generated inside the electronic device 210 using the display module 211.

In FIG. 2, an example in which the operations for the voice recognition of the user input received from the electronic device 210, the natural language understanding and generating, and the result calculation using the plan are performed on the intelligent server 230, but various embodiments of the disclosure are not limited thereto. For example, at least a partial configuration (e.g., the natural language platform 232, the execution engine 233, or the capsule database 238) of the intelligent server 230 may be embedded in the electronic device 210 (or the electronic device 101 in FIG. 1) and an operation thereof may be performed by the electronic device 210.

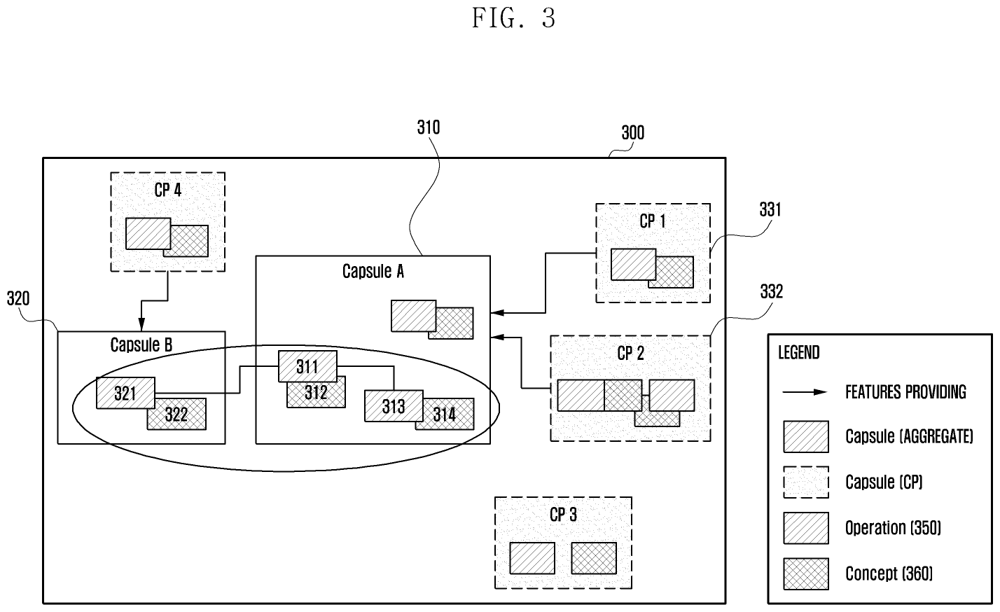

FIG. 3 is a diagram illustrating an example format of storing relationship information between concept and operation in a database according to various embodiments.

According to an embodiment, a capsule database (e.g., the capsule database 238 in FIG. 2) of an intelligent server (e.g., the intelligent server 230 in FIG. 2) may be stored in a form of concept action network (CAN) 300. The capsule database may store an operation to process a task corresponding to a voice input of the user and a parameter required for the operation in the form of concept action network (CAN).

According to an embodiment, the capsule database may store multiple capsules (capsule A 310 and capsule B 320) corresponding to respective multiple domains (e.g., applications). According to an embodiment, one capsule (e.g., capsule A 310) may correspond to one domain (e.g., a location (geo) application). In addition, at least one service provider (e.g., CP 1 331 or CP 2 332) configured to perform a function for a domain related to a capsule may correspond to one capsule. According to an embodiment, one capsule may include at least one operation 350 and at least one concept 360 configured to perform a designated function.

According to an embodiment, a natural language platform (e.g., the natural language platform 232 in FIG. 2) may use a capsule stored in the capsule database to generate a plan configured to perform a task corresponding to the received voice input. For example, a planner module (e.g., the planner module 232c in FIG. 2) of the natural language platform may use a capsule stored in the capsule database to generate a plan. For example, a plan may be generate using operations 311 and 313 and concepts 312 and 314 of capsule A 310 and an operation 321 and a concept 322 of capsule B 320.

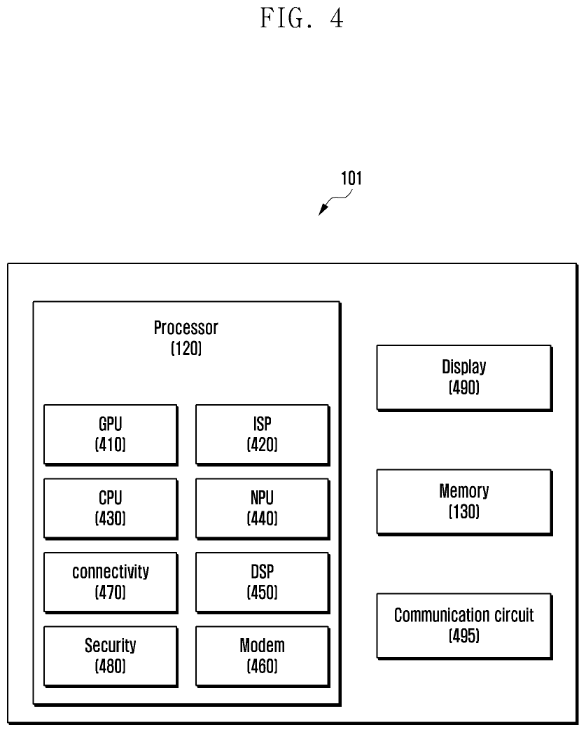

FIG. 4 is a block diagram illustrating an example configuration of an electronic device according to various embodiments.

Referring to FIG. 4, an electronic device 101 according to an embodiment of the disclosure may include a display 490 (e.g., the display module 160 or 211 in FIG. 1 or 2), a memory 130 (e.g., the memory 130 in FIG. 1), a communication circuit 495 (e.g., the communication module 190 or the communication interface 213 in FIG. 1), and/or a processor 120 (e.g., the processor 120 or 214 in FIG. 1 or 2). According to an embodiment, the electronic device 101 may include the entirety or a portion of components of the electronic device 101 or 210 described with reference to FIG. 1 or 2. For example, a portion of the configuration described above may be omitted or replaced in various embodiments of the disclosure. The electronic device 101 may include at least a portion of the configuration and/or function of the electronic device 101 in FIG. 1 and/or the electronic device 210 in FIG. 2. At least a portion of each configuration of the electronic device 101 described (or not described) may be operatively, functionally, and/or electrically connected to each other.

According to an embodiment, the display 490 may include a configuration identical or similar to the display module 160 or 211 in FIG. 1 or FIG. 2. According to an embodiment, the display 490 may display various images provided from the processor 120. According to an embodiment, the display 490 may, under control of the processor 120, visually provide an application (e.g., the application 146 in FIG. 1) being executed and various screens (e.g., a contents screen, an application execution screen, a menu screen, and/or a function execution screen) related to the application.

According to an embodiment, the display 490 may be coupled to a touch sensor, a pressure sensor capable of detecting a strength of a touch, and/or a touch panel (e.g., digitizer) configured to detect a magnetic-field-type stylus pen. According to an embodiment, the display 490 may detect a touch input, an air gesture, and/or a hovering input (or proximity input) by measuring change of a signal (e.g., a voltage, a light quantity, a resistance, an electromagnetic signal, and/or a charge quantity) for a predetermined position of the display module 490, based on the touch sensor, the pressure sensor, and/or the touch panel. For example, the display 490 may include a touch screen configured to detect a proximity touch (or hovering) and/or a touch input performed using a body part (e.g., a finger) of the user or an input device (e.g., a stylus pen). The display 490 may include at least a portion of the configuration or function of the display module 160 in FIG. 1 and/or the display module 211 in FIG. 2.

According to an embodiment, the display 490 may include a liquid crystal display (LCD), light-emitting diode (LED), organic light-emitting diode (OLED), and/or active-matrix OLED (AMOLED) display, a micro electromechanical systems (MEMS) display, or an electronic paper display, without limitation thereto. According to an embodiment, the display 490 may include a flexible display.

According to an embodiment, the memory 130 may store at least a portion of the configuration and/or function of the memory 130 in FIG. 1 and/or the memory 215 in FIG. 2 and may store software (e.g., the program 140 in FIG. 1). The memory 101 may store various applications (e.g., the application 146 in FIG. 1 or the multiple applications 219a and 239b in FIG. 2) and a program module (e.g., the client module 218 in FIG. 2) supporting an intelligent service.

According to an embodiment, the memory 130 may store various data used by at least one component (e.g., the processor 120) of the electronic device 101. In an embodiment, the data may include, for example, software (e.g., the program 140 in FIG. 1) and input data or output data with respect to a command related to the software.

According to an embodiment, the memory 130 may include a transitory memory (e.g., the transitory memory 132 in FIG. 1) or a non-transitory memory 134 (e.g., the non-transitory memory 134 in FIG. 1). According to an embodiment, the memory 130 may store a command or data received from the processor 120 in the transitory memory 1320 and store, in the non-transitory memory 134, result data acquired by processing a command or data stored in the transitory memory 132 by the processor 120.

In an embodiment, the data may include various data (e.g., training data, prompt data, a context, and/or a training model) configured to support the electronic device 101 to perform artificial intelligence-based data (e.g., shared data, routine data, or a service) sharing. In an embodiment, the data may include information related to various configurations configured to support the electronic device 101 to control an operation of sharing artificial intelligence-based data (e.g., shared data, routine data, or a service).

In an embodiment, the data may include various training data and/or parameters acquired based on training of the user through interacting with the user. In an embodiment, the data may include various schemata (or algorithms, models, networks, or functions) configured to support an artificial intelligence-based data sharing operation.

For example, the schemata configured to support the artificial intelligence-based data sharing operation in the electronic device 101 may include a neural network. In an embodiment, the neural network may include a neural network model based on at least one of an artificial neural network (ANN), a convolution neural network (CNN), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a long short-term memory network (LSTM), a classification network, plain residual network, dense network, hierarchical pyramid network, and/or a fully convolutional network, etc. According to an embodiment, the types of the neural network models are not limited the example described above.

According to an embodiment, the memory 130 may store instructions, when individually and/or collectively executed by the at least processor 120 (e.g., the processor 120 in FIG. 1), causing the electronic device 101 to perform an operation. For example, the instructions may be stored as software (e.g., the program 140 in FIG. 1) in the memory 130 and may be executed by the processor 120.

According to an embodiment, the instruction may, when executed by the at least one processor 120, cause the electronic device 101 to receive a user input requesting to share data of the electronic device 101. According to an embodiment, the instruction may, when executed by the at least one processor 120, cause the electronic device 101 to analyze the shared data selected based on the user input. According to an embodiment, the instruction may, when executed by the at least one processor 120, cause the electronic device 101 to determine whether the shared data includes personal information related to the user of the electronic device. According to an embodiment, the instruction may, when executed by the at least one processor 120, cause, in case that the shared data includes the personal information, the electronic device 101 to generate hint information related to the personal information so that information corresponding to the personal information may be inferred by an external electronic device. According to an embodiment, the instruction may, when executed by the at least one processor 120, cause the electronic device 101 to replace the personal information with the hint information in the shared data. According to an embodiment, the instruction may, when executed by the at least one processor 120, cause the electronic device 101 to share the shared data including the hint information. In the disclosure, it will be understood that that execution of the instructions may configure the processor(s) to perform the various functions and/or the processor(s) may be independently configured to perform the various functions.

For example, the instructions may include control instructions, such as arithmetic and logic operations, data movement, and/or input/output, which may be recognized by the processor 120. According to an embodiment, the software may include various applications (e.g., the application 146 in FIG. 1) configured to provide various functions (or services) (e.g., a routine function, a call function, a message function, a messenger function, an e-mail function, a social networking service (SNS) function, a search function, a media (e.g., video and/or music) reproduction function, a gaming function, and/or a wireless communication function) in the electronic device 101.

According to an embodiment, the communication circuit 495 may support wireless communication with an external electronic device using cellular wireless communications (e.g., 4G LTE or 5G NR) and/or short-range wireless communication (e.g., Wi-Fi). For example, using the communication circuit 495, the electronic device 101 may communicate with an external server configured to provide a voice assistant function through a network. According to an embodiment, the communication circuit 495 may include at least a portion of the configuration or function of the communication module 190 in FIG. 1 and/or the communication interface 213 in FIG. 2.

According to an embodiment, the processor 120 may perform an application layer processing function required by the user of the electronic device 101. According to an embodiment, the processor 120 may provide a command and control of functions for various blocks of the electronic device 101. According to an embodiment, the processor 120 may perform control of respective components of the electronic device 101 and/or calculation or data processing related to communication. For example, the processor 120 may include at least a portion of configurations and/or functions of the processor 120 in FIG. 1. According to an embodiment, the processor 120 may be operatively connected to the components of the electronic device 101. According to an embodiment, the processor 120 may load a command or data received from other components of the electronic device 101 into the memory 130, process the command or data stored in the memory 130, and store result data.

According to an embodiment, the processor 120 may include one or more processors including a processing circuit (processing circuitry) and/or executable program elements. According to an embodiment, based on the processing circuit and/or the executable program elements, the processor 120 may control (or process) overall operations related to supporting a function (e.g., an artificial intelligence-based data sharing function) of the electronic device 101.

According to an embodiment, the processor 120 may receive a user input requesting to share data of the electronic device 101. According to an embodiment, the processor 120 may perform an operation of analyzing shared data selected based on the user input. According to an embodiment, the processor 120 may perform an operation of determining whether the shared data includes personal information related to the user of the electronic device 101. According to an embodiment, the processor 120 may perform an operation of, in case that the shared data includes the personal information, generating hint information related to the personal information so that information corresponding to the personal information may be inferred by another electronic device (e.g., an external electronic device). According to an embodiment, the processor 120 may perform an operation of replacing the personal information with the hint information in the shared data. According to an embodiment, the processor 120 may perform an operation of sharing the shared data including the hint information.

According to an embodiment, the processor 120 may receive shared data from another electronic device. According to an embodiment, the processor 120 may perform an operation of analyzing the shared data. According to an embodiment, the processor 120 may perform an operation of determining whether the shared data includes personal information. According to an embodiment, the processor 120 may perform an operation of, in case that the shared data includes the hint information, generating personal information related to the hint information. According to an embodiment, the processor 120 may perform an operation of replacing the hint information with the personal information in the shared data. According to an embodiment, the processor 120 may perform an operation of generating data including personal information.

According to an embodiment, a detailed operation of the processor 120 of the electronic device 101 will be described with reference to drawings described below.

According to an embodiment, the processor 120 may correspond to an application processor (AP). According to an embodiment, the processor 120 may correspond to a system semiconductor responsible for a calculation and multimedia driving function of the electronic device 101. According to an embodiment, the processor 120 may include a technology-intensive semiconductor chip which is configured to have a system-on-chip (SoC) form to integrate various semiconductor technologies and implement components (e.g., system blocks) on a single chip.

According to an embodiment, components (e.g., system blocks) of the processor 120 may include, as shown in FIG. 4, components such as a graphic processing unit (GPU) 410, an image signal processor (ISP) 420, a central processing unit (CPU) 430, a neural processing unit (NPU) 440, a digital signal processor (DSP) 450, a modem 460, a connectivity (e.g., communication interface including communication circuitry) 470, and/or a security 480. According to an embodiment, the processor 120 may operate individually and/or collectively.

According to an embodiment, the GPU 410 may be responsible for graphics processing. According to an embodiment, the GPU 410 may perform graphics processing to express a shape, position, color, shading, movement, and/or texture of a thing (or objects) when receiving an instruction of the CPU 430.

According to an embodiment, the ISP 420 may be responsible for image processing and correction for an image and a video. According to an embodiment, the ISP 420 may perform a function of correcting unprocessed data (e.g., raw data) transmitted from an image sensor of a camera (e.g., the camera module 180 in FIG. 1) and generating an image having a form more preferred by the user. According to an embodiment, the ISP 420 may perform post-processing, such as adjusting partial brightness of an image and emphasizing a detailed portion of an image. For example, the ISP 420 may independently perform a process of tuning and correcting a quality of an image acquired through the camera so as to generate a result preferred by the user.

According to an embodiment, the ISP 420 may support an artificial intelligence (AI)-based image processing technology. According to an embodiment, the ISP 420 may support a scene segmentation (e.g., image segmentation) technology for recognizing and/or segmenting portions of a scene being captured, by linking with the NPU 440. For example, the ISP 420 may include a function for applying difference parameters to objects including the sky, bushes, and/or the skin to perform processing. According to an embodiment, when an image is captured using an artificial intelligence function, the ISP 420 may detect and display a human face or adjust brightness, a focus, and/or a color of an image using coordinates and information of the face.

According to an embodiment, the CPU 430 may be responsible for functions corresponding to those of the processor 120. According to an embodiment, the CPU 430 may operate to decode a command of the user, perform arithmetic and logical operations, and/or process data. For example, the CPU 430 may perform functions of memory, interpretation, computation, and control. According to an embodiment, the CPU 430 may control overall functions of the electronic device 101. For example, the CPU 430 may execute all software (e.g., the application 146 in FIG. 1 and/or the multiple applications 219a and 219b in FIG. 2) of the electronic device 101 on an operating system (OS) and control a hardware device. According to an embodiment, the CPU 430 may execute an application and control overall operations of the processor 120 to perform neural network-based tasks required according to the execution of the application.

According to an embodiment, the CPU 430 may store a command or data, as at least a portion of data processing or calculating, in a volatile memory (e.g., the volatile memory 132 in FIG. 1) of the memory 130, and process the command and the data stored in the volatile memory and then store result data in a non-volatile memory (e.g., the non-volatile memory 134 in FIG. 1) of the memory 130.

According to an embodiment, the CPU 430 may include a single processor core or multiple processor cores (multi-core). According to an embodiment, the CPU 430 may correspond to a programmable processor which may store executable instructions (e.g., instructions allowing calculation of the CPU 430) and execute the instructions.

According to an embodiment, the CPU 430 may operate on a multi-domain. According to an embodiment, the CPU 430 may operate in a domain environment of a normal world (e.g., a non-secure world, framework, or non-secure environment) and a multi-domain environment of a secure world (e.g., a framework or secure environment). In an embodiment, the domain of the secure world may include one or more domains (e.g., a trusted OS, a trustzone, and/or a virtualization framework).

According to an embodiment, the NPU 440 may be responsible for processing optimized for artificial intelligence deep-learning algorithms. According to an embodiment, the NPU 440 may correspond to a processor optimized for deep-learning algorithm calculation (e.g., artificial intelligence calculation) and may process big data as quickly and efficiently as a human neural network. For example, the NPU 440 may be mainly used for artificial intelligence calculation. According to an embodiment, the NPU 440 may be responsible for automatically adjusting a focus by recognizing an object, environment, and/or person in a background when an image is captured through the camera, automatically switching a capturing mode of the camera module 180 to a food mode when photographing food, and/or erasing unnecessary object from a photographed result. According to an embodiment, the NPU 440 may be responsible for a process of analyzing personal information or hint information from at least one piece of information of shared data and performing replacing between information based on an analysis result so as to configure user-specific data.

According to an embodiment, the electronic device 101 may interact with all processors, such as the GPU 410, the ISP 420, the CPU 430, and the NPU 440 to support integrated machine learning processing.

According to an embodiment, the DSP 450 may represent an integrated circuit configured to help rapid processing of a digital signal. According to an embodiment, the DSP 450 may perform a function of changing an analog signal to a digital signal for high-speed processing.

According to an embodiment, the modem 460 may perform a function to allow the electronic device 101 to use various communication functions. For example, the modem 460 may support communication, such as call and data transmission or reception while transmitting or receiving a signal to or from a base station. According to an embodiment, the modem 460 may include an integrated modem (e.g., a cellular modem, an LTE modem, a 5G modem, a 5G-advanced modem, and a 6G modem) configured to support communication technologies including long term evolution and 2G to 5G. According to an embodiment, the modem 460 may include an artificial intelligence model to which an artificial intelligence algorithm has been applied.

According to an embodiment, the connectivity 470 may support wireless data transmission based on IEEE 802.11. According to an embodiment, the connectivity 470 may support a communication service based on IEEE 802.11 (e.g., Wi-Fi) and/or 802.15 (e.g., Bluetooth, Zigbee, and UWB). For example, the connectivity 470 may support a communication service targeting random people in a localized area such as indoors using an unlicensed band.

According to an embodiment, the security 480 may provide an independent security execution environment between data or services stored in the electronic device 101. According to an embodiment, the security 480 may be responsible for preventing and/or reducing hacking from outside through software and hardware security during user authentication when a service of the electronic device 101, such as biometrics, mobile identification, and/or payments, is provided. For example, the security 480 may provide an independent security execution environment in device security to reinforce the security of the electronic device 101 itself and in a security service based on user information, such as mobile identification, payments, and a car key in the electronic device 101.

According to an embodiment, operations performed in the processor 120 may be implemented by performing instructions stored in a non-transitory computer-readable recording medium (or computer program product or storage medium). For example, the recording medium may include a non-transitory computer-readable recording medium configured to store a program for executing various operations performed by the processor 120.

The various embodiments described in the disclosure may be implemented in a recording medium readable by a computer or similar device using software, hardware, or a combination thereof. According to hardware implementation, the operations described in an embodiment may be implemented using at least one of application specific integrated circuits (ASICs), digital signal processors (DSPs), digital signal processing devices (DSPDs), programmable logic devices (PLDs), and field programmable gate arrays (FPGAs), processors, controllers, micro-controllers, microprocessors, and/or other electrical units to perform functions.

An embodiment provides a non-transitory computer-readable recoding medium (or computer program product or storage medium) configured to record a program allowing various operations to be performed (or executed) in the electronic device 101.

The operations may include an operation of analyzing shared data selected based on a user input requesting sharing data of the electronic device 101, an operation of determining whether the shared data includes personal information related to the user of the electronic device 101, an operation of, in case that the shared data includes the personal information, generating hint information related to the personal information so that information corresponding to the personal information may be inferred by another electronic device, an operation of replacing the personal information with the hint information in the shared data, and an operation of sharing the shared data including the hint information.

The electronic device according to an example embodiment of the disclosure may include a display, a memory configured to store instructions, and at least one processor including a processing circuitry and operatively connected to the display and the memory. According to an example embodiment, the memory may store instructions, wherein at least one processor, individually and/or collectively, is configured to execute the instructions and to cause the electronic device to perform an operation.

According to an example embodiment, at least one processor, individually and/or collectively, is configured to cause the electronic device to: receive an input requesting to share data of the electronic device; analyze the shared data selected based on the input; determine whether the shared data includes personal information related to a user of the electronic device; based on the shared data including the personal information, generate hint information related to the personal information so that information corresponding to the personal information may be inferred by an external electronic device; replace the personal information with the hint information in the shared data; and share the shared data including the hint information.

According to an example embodiment, at least one processor, individually and/or collectively, may be configured to cause the electronic device to determine the personal information from at least one piece of information of the shared data.

According to an example embodiment, at least one processor, individually and/or collectively, may be configured to cause the electronic device to determine feature data from the personal information and analyze a context of the personal information from the feature data, based on linguistic context analysis.

According to an example embodiment, at least one processor, individually and/or collectively, may be configured to cause the electronic device to generate hint information having a specific linguistic context from the feature data of the personal information, based on linguistic context analysis.

According to an example embodiment, at least one processor, individually and/or collectively, may be configured to cause the electronic device to remove the personal information from the shared data, add hint information, which has replaced the personal information, to the shared data, and reconfigure the shared data.

According to an example embodiment, at least one processor, individually and/or collectively, may be configured to cause the electronic device to transmit the shared data to an external electronic device connected through designated communication to share the shared data of the electronic device with the external electronic device.

According to an example embodiment, at least one processor, individually and/or collectively, may be configured to cause the electronic device to receive shared data from the external electronic device; analyze the shared; determine whether the shared data includes hint information; based on the shared data include hint information, generate personal information related to the hint information; replace the hint information with the personal information in the shared data; and generate data including the personal information.

According to an example embodiment, at least one processor, individually and/or collectively, may be configured to cause the electronic device to determine the hint information from at least one piece of information of the shared data.

According to an example embodiment, at least one processor, individually and/or collectively, may be configured to cause the electronic device to change an item corresponding to the hint information to personal information related to the user of the electronic device in the shared data.

According to an example embodiment, at least one processor, individually and/or collectively, may be configured to cause the electronic device to determine feature data from the hint information and analyze a context of the hint information from the feature data, based on linguistic context analysis.

According to an example embodiment, at least one processor, individually and/or collectively, may be configured to cause the electronic device to determine whether there is a function not supported by the electronic device, based on the hint information.

According to an example embodiment, at least one processor, individually and/or collectively, may be configured to cause, based on there being an unsupported function, the electronic device to determine replaceable function information and the personal information of the unsupported function, based on the hint information and change the personal information of the unsupported function, based on the replaceable function information.

According to an example embodiment, at least one processor, individually and/or collectively, may be configured to cause the electronic device to store the data but not the shared data.

Hereinafter, a method of operating an electronic device 101 according to various example embodiments will be described in greater detail. Operations performed by the electronic device 101 according to various embodiments may be executed by the processor 120 including various processing circuitry and/or executable program elements of the electronic device 101. According to an embodiment, the operations performed by the electronic device 101 may be stored in the memory 130 as instructions and individually and/or collectively performed (or executed) by the processor 120.

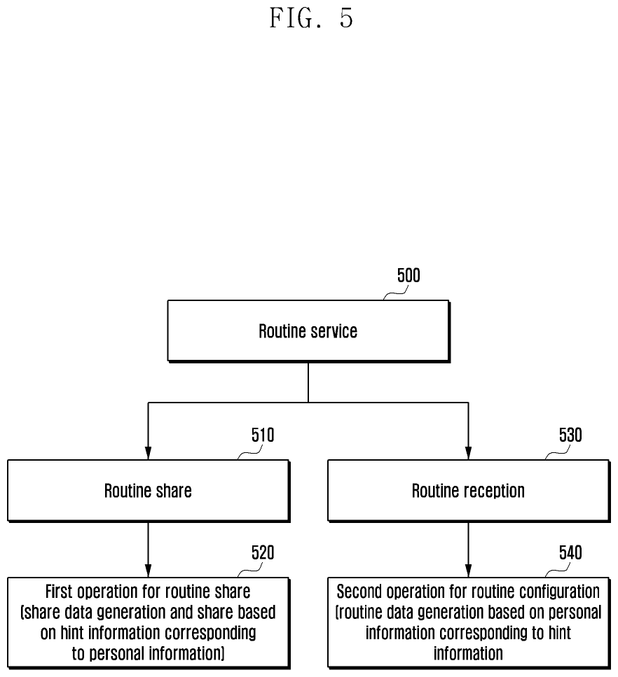

FIG. 5 is a diagram illustrating an example operation of an electronic device according to various embodiments.

According to an embodiment, FIG. 5 may illustrate an example of an operation of supporting a routine-related operation, based on artificial intelligence (AI) in the electronic device 101 according to an embodiment. According to an embodiment, the electronic device 101 may share a routine according to the configuration of the electronic device 101 with another electronic device, and configure a routine shared from another electronic device as a routine of the electronic device 101.

An operation supported in the electronic device 101 according to an embodiment of the disclosure may include, for example, a routine sharing operation and a routine configuration operation as the example of operations shown in FIG. 5. Operations illustrated in FIG. 5 is merely an example according to an embodiment of the operation of the electronic device 101, and at least some operations may be changed, performed in parallel, or performed as independent operations, or at least some other operations may be performed complementary to at least some operations. According to an embodiment, operations 500 to 540 may be performed by at least one processor 120 (e.g., the processor 120 or 214 in FIG. 1, 2, or 4) of the electronic device 101.

Referring to FIG. 5, the electronic device 101 may support a routine-related operation 500. In an embodiment, the routine-related operation 500 may include, for example, a service of executing a routine configured in the electronic device 101 (e.g., a routine execution service), a service of sharing a routine configured in the electronic 101 with another electronic device (e.g., a routine sharing service), or a service of configuring a routine received (e.g., sharing-requested) from another electronic device as a routine of the electronic device 101 (e.g., a routine reception service).

According to an embodiment, the routine-related operation 500 supported by the electronic device 101 may include a service related to routine configuration according to routine sharing 510 and routine reception 530. According to an embodiment, the electronic device 101 may support a routine-related operation of sharing a routine configured in the electronic device 101 with another external electronic device according to the routine-related operation 500. According to an embodiment, the electronic device 101 may support a routine-related operation of receiving a routine configured in another electronic device and configuring the routine as a routine of the electronic device 101 according to the routine-related operation 500.

According to an embodiment, during the routine sharing 510, the electronic device 101 may process the routine-related operation 500, based on a first operation for routine sharing. For example, the electronic device 101 may generate and share 520 shared data (e.g., processed routine data) based on hint information corresponding to personal information. In an embodiment, the personal information may correspond to sensitive information related to user privacy or related to the user, and/or may include various information directly or indirectly related to the user. For example, the personal information may include financial information, photo information, payment information, account information, mobile ID information, location (or place) information, health information, contact utilization information, phone number utilization information, personal registered device information (e.g., information related to wireless communication (e.g., Wi-Fi, or BT) connection (or pairing) device), and/or user-designated keyword information. In an embodiment, the hint information may be inferred from the personal information through artificial intelligence (e.g., generative artificial intelligence), or may include information including a condition and/or action allowing acquisition from the personal information. According to an embodiment, the hint information may be provided in a text form. A description related to an example related to the personal information and the hint information according to an embodiment will be given below.

According to an embodiment, the electronic device 101 may remove personal information from routine data of a routine to be shared. According to an embodiment, the electronic device 101 may generate hint information corresponding to personal information of the routine data based on artificial intelligence and replace a parameter (or prompt) corresponding to the personal information in the routine data with the hint information. According to an embodiment, the electronic device 101 may transmit the routine data in which the personal information has been replaced with the hint information to another designated electronic device and share same.

According to an embodiment, during the routine reception 530 from another electronic device, the electronic device 101 may process the routine-related operation 500, based on a second operation for routine configuration. For example, the electronic device 101 may generate 540 routine data based on personal information corresponding to hint information. According to an embodiment, the electronic device 101 may generate personal information corresponding to hint information of the routine data based on artificial intelligence and replace a parameter (or prompt) corresponding to the hint information in the routine data with the personal information. According to an embodiment, the electronic device 101 may configure a routine of the electronic device 101, based on the routine data in which the hint information has been replaced with the personal information.

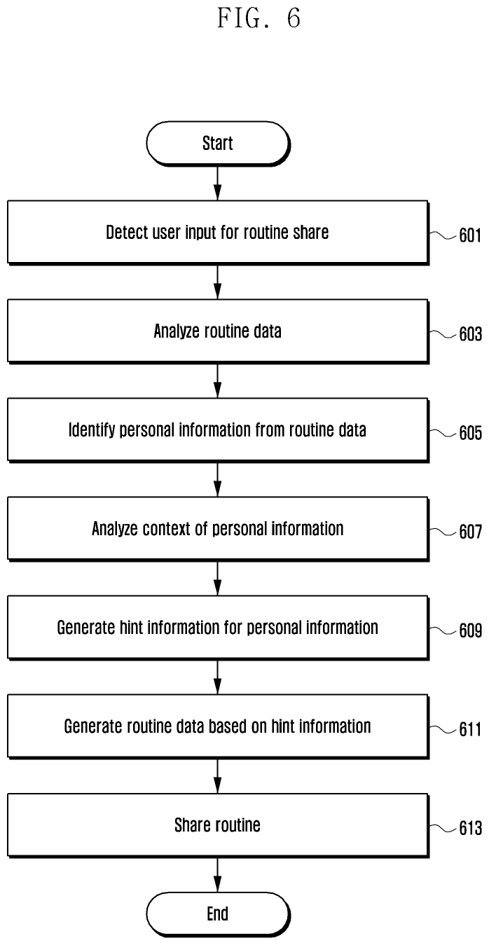

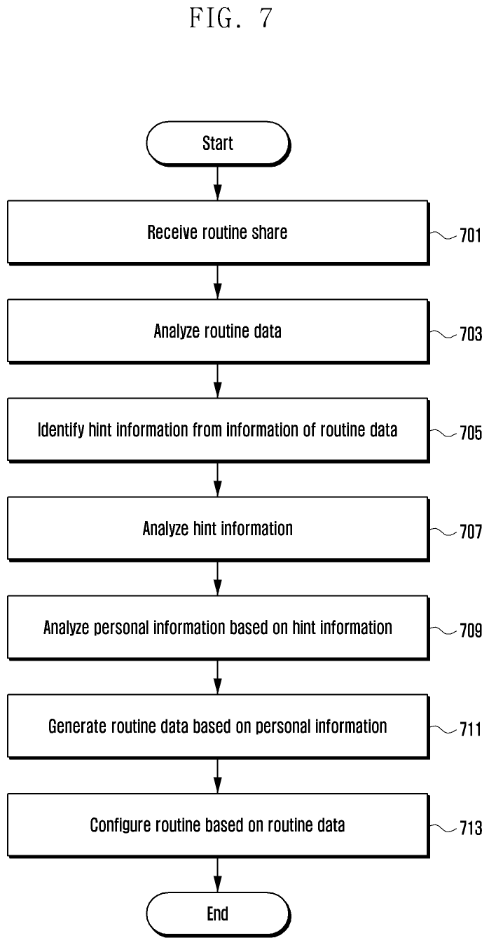

According to an embodiment, the electronic device 101 may detect a trigger related to the routine-related operation (e.g., routine execution, routine sharing, or routine reception). According to an embodiment, the electronic device 101 may execute a designated routine based on the detection (e.g., routine execution condition detection) of the trigger related to the routine execution. According to an embodiment, the electronic device 101 may perform (e.g., perform an operation of a transmission side in FIG. 6) an operation (e.g., the first operation 520) for designated routine-based routine sharing based on the trigger detection (e.g., routine sharing detection based on a user input) related to the routine sharing. According to an embodiment, the electronic device 101 may perform (e.g., perform an operation of a reception side in FIG. 7) an operation (e.g., the second operation 540) for received routine-based routine configuration based on the trigger detection (e.g., reception of routine sharing from another electronic device) related to the routine reception.

In an embodiment of the disclosure, for convenience of explanation, the operation of the electronic device 101 is divided into transmission-side and reception-side operations, or transmission-side and reception-side operations are explained in relation to a first electronic device (e.g., a transmission side electronic device) and a second electronic device (e.g., a reception side electronic device or another electronic device), respectively, but the disclosure is not limited thereto. For example, the electronic device 101 may perform both the transmission side operation and the reception side operation according to the routine-related operation.

According to an embodiment, in case that the first operation (e.g., the transmission side operation) for the routine sharing is performed, the electronic device 101 (e.g., the first electronic device) may analyze (e.g., identify) personal information from the routine data selected for the sharing based on artificial intelligence and remove the personal information from the routine data. According to an embodiment, the electronic device 101 may generate hint information related to a designated condition and/or designated action corresponding to personal information, based on artificial intelligence. According to an embodiment, the electronic device 101 may transmit the routine data in which the personal information has been replaced with the hint information to another designated electronic device (e.g., the second electronic device).

According to an embodiment, in case that routine data is received and the second operation (e.g., the reception side operation) for routine configuration based on the received routine data, the electronic device 101 (e.g., the second electronic device) may analyze (e.g., identify) hint information from the received routine data, based on artificial intelligence. According to an embodiment, the electronic device 101 may determine and map a designated condition and/or designated action corresponding to the personal information of the electronic device 101 from hint information, based on artificial intelligence. According to an embodiment, the electronic device 101 may configure a routine of the electronic device 101, based on the routine data in which the hint information has been replaced with the personal information.

In an embodiment of the disclosure, for convenience of explanation, the description is given of an example in which routine data is shared among electronic devices by cross-referencing and changing personal information and hint information within the routine data based on routine sharing, but the disclosure is not limited thereto. For example, according to an embodiment of the disclosure, in addition to the routine sharing, in case that there is personal information in various data (e.g., shared data) sharable among electronic devices, the personal information in the shared data may be replaced with the hint information and then provided, or the hint information in the received shared data may be replaced with the personal information and then provided.

FIG. 6 is a flowchart illustrating an example method of operating an electronic device according to various embodiments.

According to an embodiment, FIG. 6 may illustrate an example of an operation of supporting a routine sharing operation (e.g., the first operation in FIG. 5) in which the electronic device 101 shares a routine of the electronic device 101 with another electronic device, based on artificial intelligence.

An operation supported in the electronic device 101 according to an embodiment of the disclosure may be performed according to the flowchart shown in FIG. 6, for example. The flowchart shown in FIG. 6 is merely an example according to an embodiment of the operation of the electronic device 101, and at least some operations may be changed in the order thereof, performed in parallel, or performed as independent operations, or at least some other operations may be performed complementary to at least some operations. According to an embodiment, operations 601 to 613 may be performed by at least one processor (e.g., the processor 120 or 214 in FIG. 1, 2, or 4) of the electronic device 101.

According to an embodiment, operations shown in FIG. 6 may be combined with the operations shown in FIG. 5 to be performed heuristically, may be replaced in terms of at least some of the described operations and combined with at least some other operations to be performed heuristically, or may be performed heuristically as detailed operations of at least some operations of the described operations.

As shown in FIG. 6, the method performed by the electronic device 101 according to an embodiment may include an operation 601 of detecting a user input for routine sharing, an operation 603 of analyzing routine data, an operation 605 of identifying personal information from the routine data, an operation 607 of analyzing a context of the personal information, an operation 609 of generating hint information for the personal information, an operation 611 of generating routine data based on the hint information, and an operation 613 of sharing a routine.

Referring to FIG. 6, in operation 601, the processor 120 of the electronic device 101 may perform an operation of detecting a user input for routine sharing. According to an embodiment, the processor 120 may execute a routine application (or a routine-related operation). According to an embodiment, the processor 120 may receive a user input configured to cause at least one of various routines configured (or registered) by the user to be selected on an execution screen (e.g., a routine screen) and request sharing of the selected at least one routine. According to an embodiment, the processor 120 may determine a trigger of a routine sharing operation, based on the user input to execute a sharing function configured to allow sharing of a designated routine.

In operation 603, the processor 120 may perform an operation of analyzing routine data. According to an embodiment, the processor 120 may analyze routine data (e.g., a parameter) of the routine selected based on the user input. In an embodiment, the routine data may include at least one piece of configuration information (or a parameter or data) related to a condition and action configuring the routine. For example, the routine may be executed when the routine data includes the condition and action designated by the user and the processor 120 automatically executes a designated action when the designated condition is satisfied.

According to an embodiment, the personal information in the routine data may include, for example, various information such as location (or location information), contact utilization information, phone number utilization information, communication utilization information, and/or a keyword designated by the user. According to an embodiment, the personal information may be divided into a condition filter target and an action filter target.

According to an embodiment, the condition filter target may include a condition related to an individual user (or direct condition) among various conditions for routine execution in the electronic device 101, such as a location condition, a location arrival condition, (e.g., GPS information), a communication utilization information such as predetermined Wi-Fi or predetermined BT, a predetermined “word” (e.g., a user-designated word) when a notification is received, a text from a predetermined sender, a predetermined “word” (e.g., a user-designated word) when a text is received, and/or a case in which text is received.

According to an embodiment, the action filter target may include various actions automatically executable when a condition for routine execution is satisfied in the electronic device 101, such as connecting or disconnecting VPN, connecting or disconnecting secure Wi-Fi, connecting or disconnecting BT, registering an notification by generating the notification including a word designated by the user, reading a reception notification in TTS, and/or displaying multiple application selection screens when a condition is satisfied and an action is executed (e.g., information configured to display an “application selection screen” of applications installed in the electronic device 101).

In operation 605, the processor 120 may perform an operation of identifying personal information from the routine data. According to an embodiment, the processor 120 may determine (or extract) information (or a parameter or data) related to the personal information from the routine data from an analysis result of the routine data.

In operation 607, the processor 120 may perform an operation of analyzing a context of the personal information. According to an embodiment, the processor 120 may determine feature data (or a feature word) from the personal information identified from the routine data through artificial intelligence. According to an embodiment, the processor 120 may perform linguistic context analysis from feature data (e.g., feature word) through artificial intelligence. In an embodiment, the linguistic context analysis may include analysis in consideration of the context surrounding an essence of personal information (e.g., feature data).

In operation 609, the processor 120 may perform an operation of generating hint information for the personal information. According to an embodiment, the processor 120 may generate hint information which may replace (correspond to) the personal information in the routine data. According to an embodiment, the processor 120 may generate hint information having a predetermined linguistic context, based on the linguistic context analysis from the feature data of the personal information through artificial intelligence. A description related to an example related to the personal information and the hint information according to an embodiment will be given below.

In operation 611, the processor 120 may perform an operation of generating routine data based on the hint information. According to an embodiment, the processor 120 may reconfigure original routine data (or existing routine data) to generate new routine data (e.g., shared routine data or processed routine data). According to an embodiment, the processor 120 may replace the personal information with the hint information in the original routine data.

According to an embodiment, the replacing of the personal information with the hint information in the routine data may be represent as an example in <Table 1> below.

TABLE 1

| Original routine data | Shared routine data |
|---|---|
| { | { |
| ... | ... |
| “instanceExtra”: “my room & | “instanceExtra”: “ ” |
| 00:00:00:00:AA:AA” | “hint”: “home wifi” |
| ... | ... |
| } | } |

Here, “my room & 00:00:00:00:AA:AA” of the original routine data in <Table 1> may represent the personal information and “hint”: “home wifi” of the shared routine data may represent the hint information. As shown in <Table 1>, in case of the shared routine data, item corresponding to the personal information may be removed (e.g., providing a black space) and the hint information which may configure the personal information may be added. According to an embodiment, it is also possible to replace the item of the personal information with the hint information in the shared routine data. According to an embodiment, the hint information may be provided in a text form, but without limitation thereto, may be provided in various forms. In the example in <Table 1>, the hint information may be generated as “home wifi” configured to allow inference of Wi-Fi connection and location, based on the personal information related to a Wi-Fi address of a user's room, so that a corresponding routine may be configured in another electronic device. According to an embodiment, a description related to an example related to the replacing with the hint information based on data of the personal information will be given below.

In operation 613, the processor 120 may perform an operation of sharing a routine. According to an embodiment, the processor 120 may share the routine, based on that the generated routine data is transmitted to another electronic device designated by the user. According to an embodiment, the processor 120 may transmit the routine data, in which the personal information has been removed from the selected routine data and replaced with the hint information, to another electronic device connected through designated communication (e.g., direct or wireless communication). For example, the processor 120 may transmit the routine data to another electronic device designated by the user through the designated communication so as to share the routine of the electronic device 101 with another electronic device.

FIG. 7 is a flowchart illustrating an example method of operating an electronic device according to various embodiments.

According to an embodiment, FIG. 7 may illustrate an example of an operation of supporting a routine configuration operation (e.g., the second operation in FIG. 5) in which the electronic device 101 configures a routine shared (or received) from another electronic device as the routine of the electronic device 101, based on artificial intelligence.

An operation supported in the electronic device 101 according to an embodiment of the disclosure may be performed according to the flowchart shown in FIG. 7, for example. The flowchart shown in FIG. 7 is merely an example according to an embodiment of the operation of the electronic device 101, and at least some operations may be changed in the order thereof, performed in parallel, or performed as independent operations, or at least some other operations may be performed complementary to at least some operations. According to an embodiment, operations 701 to 713 may be performed by at least one processor (e.g., the processor 120 or 214 in FIG. 1, 2, or 4) of the electronic device 101.

According to an embodiment, operations shown in FIG. 7 may be combined with the operations shown in FIG. 5 or 6 to be performed heuristically, may be replaced in terms of at least some of the described operations and combined with at least some other operations to be performed heuristically, or may be performed heuristically as detailed operations of at least some operations of the described operations.

As shown in FIG. 7, the method performed by the electronic device 101 according to an embodiment may include an operation 701 of receiving routine sharing, an operation 703 of analyzing routine data, an operation 705 of identifying hint information from the routine data, an operation 707 of analyzing the hint information, an operation 709 of analyzing personal information based on the hint information, an operation 711 of generating routine data based on the personal information, and an operation 713 of configuring a routine based on the routine data.

Referring to FIG. 7, in operation 701, the processor 120 of the electronic device 101 may perform an operation of receiving routine sharing. According to an embodiment, the processor 120 may receive routine data from another electronic device through designated communication. According to an embodiment, the processor 120 may receive routine data which is transferred from another electronic device connected through direct or wireless communication to the electronic device 101. According to an embodiment, the processor 120 may determine a routine share request for configuring as a routine of the electronic device 101 using the routine data, based on the reception of the routine data.

In operation 703, the processor 120 may perform an operation of analyzing routine data. According to an embodiment, the processor 120 may analyze the received routine data (e.g., a parameter) based on the user input (e.g., routine share request acceptance). In an embodiment, the routine data may include at least one piece of configuration information (or a parameter or data) related to a condition and action configuring the routine. For example, the routine data may include a condition and action designated by the user of another electronic device. According to an embodiment, the processor 120 may analyze the personal information having removed (or replaced) from various information (or parameters or data) of the received routine data. According to an embodiment, the processor 120 may perform data analysis to perform an operation of filling at least one empty item in the routine data with personal information through artificial intelligence, based on the analysis of the received routine data.

In operation 705, the processor 120 may perform an operation of identifying hint information from the information of the routine data. According to an embodiment, the processor 120 may determine (or extract) the hint information (or a parameter or data) related to the personal information from the routine data from an analysis result of the routine data.

In operation 707, the processor 120 may perform an operation of analyzing the hint information. According to an embodiment, the processor 120 may determine feature data (or a feature word) from the hint information identified from the routine data through artificial intelligence. According to an embodiment, the processor 120 may perform linguistic context analysis from feature data (e.g., feature word) through artificial intelligence. In an embodiment, the linguistic context analysis may include analysis in consideration of the context surrounding an essence of personal information (e.g., feature data).

In operation 709, the processor 120 may perform an operation of analyzing the personal information based on the hint information. According to an embodiment, the processor 120 may determine personal information (e.g., personal information analysis), which may replace (or correspond to) the hint information in the routine data. According to an embodiment, the processor 120 may generate personal information (e.g., a parameter or data related to personal information) corresponding to the electronic device 101, based on the hint information in the routine data. According to an embodiment, the processor 120 may analyze a designated condition and/or action, based on linguistic context analysis from feature data of the hint information through artificial intelligence. According to an embodiment, the processor 120 may perform an operation of determining personal information for the electronic device 101 from the hint information through artificial intelligence and mapping a condition and/or action corresponding to the personal information (e.g., personal information mapping), based on a determination result. According to an embodiment, when it is determined that a partial function is not supported by the electronic device 101 or is changed through the received routine data, the processor 120 may replace same with a similar function through artificial intelligence and generate personal information and map a condition and/or action corresponding to the personal information.

In operation 711, the processor 120 may perform an operation of generating routine data based on the personal information. According to an embodiment, the processor 120 may reconfigure the received routine data and generate new routine data. According to an embodiment, the processor 120 may replace the hint information with the personal information in the received routine data. For example, the processor 120 may replace an item corresponding to the personal information with a parameter for a condition and action inferred from the hint information in the routine data. For example, the processor 120 may replace an empty item (or a hint information item) in the routine data with the personal information corresponding to the hint information and generate the routine data.

In operation 713, the processor 120 may perform an operation of configured a routine based on the routine data. According to an embodiment, the processor 120 may configure a routine of the electronic device 101, using the generated routine data. According to an embodiment, the processor 120 may execute the routine by automatically executing a designated action when a designated condition is satisfied, based on the routine configuration.

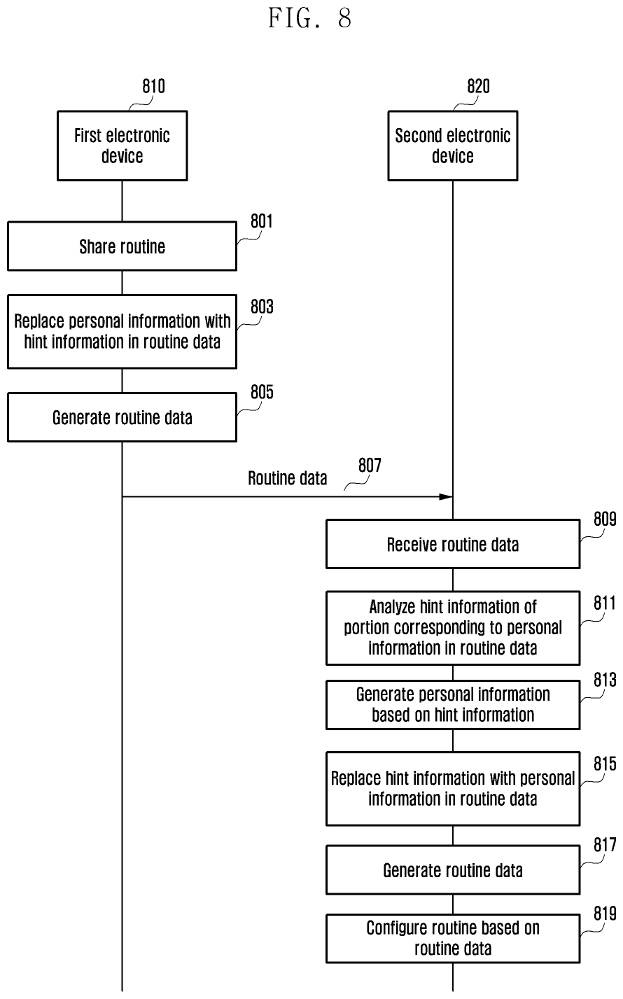

FIG. 8 is a signal flow diagram illustrating an example operation of providing a routine-related operation between electronic devices according to various embodiments.

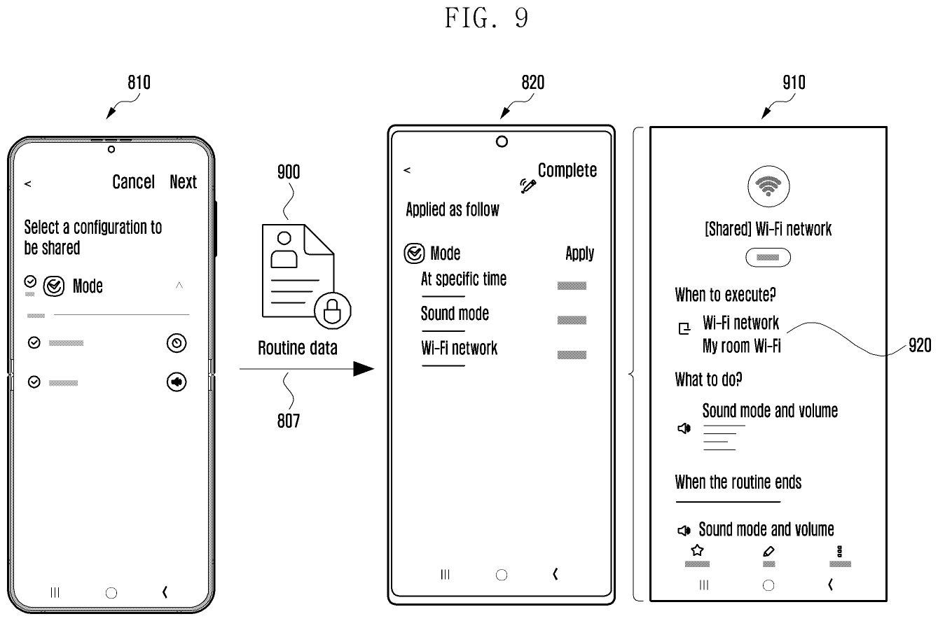

FIG. 9 is a diagram illustrating an example operation of providing a routine-related operation between electronic devices according to various embodiments.

According to an embodiment, for convenience of explanation, the transmission-side and reception-side operations have been described based on the first electronic device 810 (e.g., a transmission side electronic device) and the second electronic device 820 (e.g., a reception side electronic device or another electronic device) in the example in FIG. 8, but the disclosure is not limited thereto. For example, the electronic device 101 may perform both the transmission side operation and the reception side operation according to the routine-related operation.

According to an embodiment, operations shown in FIG. 8 may be combined with the operations shown in FIG. 5 or 7 to be performed heuristically, may be replaced in terms of at least some of the described operations and combined with at least some other operations to be performed heuristically, or may be performed heuristically as detailed operations of at least some operations of the described operations.

Referring to FIGS. 8 and 9, in operation 801, the first electronic device 810 may initiate an operation of routine sharing. According to an embodiment, the first electronic device 810 may receive a user input configured to cause at least one of various routines configured (or registered) by the user to be selected on an execution screen (e.g., a routine screen) and request sharing of the selected at least one routine. According to an embodiment, the first electronic device 810 may determine an initiation of a routine sharing operation, based on the user input to execute a sharing function configured to allow sharing of a designated routine.

In operation 803, the first electronic device 810 may replace the personal information with the hint information in the routine data. The first electronic device 810 may analyze the routine data (e.g., a parameter) of the selected routine. According to an embodiment, the first electronic device 810 may identify the personal information from the routine data. According to an embodiment, the first electronic device 810 may determine (or extract) the personal information from the routine data from an analysis result of the routine data. According to an embodiment, the first electronic device 810 may generate the hint information having a predetermined linguistic context, based on the linguistic context analysis from feature data of the personal information. A description related to an example related to the personal information and the hint information according to an embodiment will be given below.

In operation 805, the first electronic device 810 may generate routine data (e.g., the routine data 900 in FIG. 9). According to an embodiment, the first electronic device 810 may perform an operation of generating the routine data 900, based on the hint information. According to an embodiment, the first electronic device 810 may reconfigure original routine data to generate new routine data 900 (e.g., shared routine data or processed routine data). According to an embodiment, the first electronic device 810 may replace the personal information with the hint information in the original routine data. According to an embodiment, a description related to an example related to the replacing with the hint information based on data of the personal information will be given below.

In operation 807, the first electronic device 810 may transmit the routine data 900 to the second electronic device 820. According to an embodiment, the first electronic device 810 may transmit a routine share request to another electronic device, based on that the generated routine data 900 is transmitted to another electronic device designated by the user. According to an embodiment, the first electronic device 810 may transmit the routine data 900, in which the personal information has been removed from the selected routine data and replaced with the hint information, to another electronic device connected through designated communication (e.g., direct or wireless communication).

In operation 809, the second electronic device 820 may receive the routine data 900. According to an embodiment, the second electronic device 820 may receive the routine data 900 from the first electronic device 810 through designated communication. According to an embodiment, the second electronic device 820 may determine a routine share request for configuring a routine of the second electronic device 820 using the routine data 900, based on the reception of the routine data 900.

In operation 811, the second electronic device 820 may analyze the hint information of a portion (or item) corresponding to the personal information in the routine data 900. According to an embodiment, the second electronic device 820 may perform an operation of analyzing the routine data 900. According to an embodiment, the second electronic device 820 may analyze the received routine data 900 based on the user input (e.g., routine share request acceptance). According to an embodiment, the second electronic device 820 may analyze the personal information having removed (or replaced) from various information (or parameters or data) of the received routine data 900. According to an embodiment, the second electronic device 820 may perform data analysis to perform an operation of filling at least one empty item (e.g., the Wi-Fi network item 920 in FIG. 9) in the routine data 900 with the personal information through artificial intelligence, based on the analysis of the received routine data 900. According to an embodiment, the second electronic device 820 may identify the hint information from the routine data 900. According to an embodiment, the second electronic device 820 may determine (or extract) the hint information (or a parameter or data) related to the personal information from the routine data 900 from an analysis result of the routine data 900. According to an embodiment, the second electronic device 820 may determine feature data (or a feature word) from the hint information. According to an embodiment, the second electronic device 820 may analyze the hint information from the feature data (e.g., the feature word) based on the linguistic context analysis.

In operation 813, the second electronic device 820 may generate the personal information, based on the hint information. According to an embodiment, the second electronic device 820 may determine personal information replaceable (or corresponding to the hint information) in the second electronic device 820, based on the hint information. According to an embodiment, the second electronic device 820 may generate personal information (e.g., a parameter or data related to personal information) corresponding to the second electronic device 820 from the feature data of the hint information, based on the linguistic context analysis.

In operation 815, the second electronic device 820 may replace the hint information with the personal information in the routine data 900. According to an embodiment, the second electronic device 820 may map a condition and/or action corresponding to the personal information (e.g., personal information mapping), based on the routine data 900. According to an embodiment, the second electronic device 820 may configure an item corresponding to the personal information of the first electronic device 810 based on the personal information of the second electronic device 820 in the routine data 900. For example, as the example 910 in FIG. 9, the second electronic device 820 may replace the Wi-Fi network item 920 with the personal information (e.g., My room Wi-Fi) of the second electronic device 820. According to an embodiment, when it is determined that a partial function is not supported by the electronic device 820 or is changed from the routine data 900, the second electronic device 820 may replace same with a similar function, and generate personal information and map a condition and/or action corresponding to the personal information.

In operation 817, the second electronic device 820 may generate routine data (e.g., the routine data to be applied to the second electronic device 820). According to an embodiment, the second electronic device 820 may replace the hint information with the personal information in the routine data 900. For example, the second electronic device 820 may replace an item corresponding to the personal information with a parameter for a condition and action inferred from the hint information in the routine data 900. According to an embodiment, the second electronic device 820 may replace an empty item (or a hint information item) in the routine data 900 with the personal information corresponding to the hint information and generate the routine data (e.g., the routine data to be applied to the second electronic device 820).

In operation 819, the second electronic device 820 may generate a routine, based on the routine data. According to an embodiment, the second electronic device 820 may configure a routine of the second electronic device 820, using the generated routine data. According to an embodiment, the second electronic device 820 may execute the routine by automatically executing a designated action when a designated condition is satisfied, based on the routine configuration.

As illustrated in FIGS. 8 and 9, the first electronic device 810 and the second electronic device 820 may transmit and receive routine data from which the personal information has been removed. According to an embodiment, the first electronic device 810 may provide, to the second electronic device 820, the routine data from which the personal information (e.g., the Wi-Fi address information and/or location information such as GPS, a house, and an office) has been removed. According to an embodiment, the second electronic device 820 may receive the routine data from which the personal information has been removed and map an empty personal information item to the personal information of the second electronic device 820 in the routine data.

According to an embodiment, the first electronic device 810 may replace the personal information with the hint information and provide the routine data including the hint information to the second electronic device 820. In an embodiment, the personal information may correspond to personal information (e.g., the personal information of the first electronic device 810) related to a condition and action configured to control the operation of the first electronic device 810. According to an embodiment, the second electronic device 820 may generate, based on the hint information corresponding to the personal information of the first electronic device 810, information (e.g., the personal information of the second electronic device 820) related to a condition and action configured to control the operation of the second electronic device 810 or an operation of another electronic device (e.g., a wearable device such as a watch or a ring, earbuds, and/or a peripheral electronic device (e.g. a TV, a refrigerator, an external speaker)) connected to the second electronic device 820.

According to an embodiment, the second electronic device 820 may, in case that the routine data including at least one piece of hint information is received from the first electronic device 810, analyze and determine at least one piece of personal information (or user information) corresponding to the hint information and generate routine data in which the hint information is replaced with the personal information in the received routine data. According to an embodiment, the second electronic device 820 may add a new routine to the second electronic device 820, based on the routine data and control the second electronic device 820 and/or at least one other electronic device connected to the second electronic device 820 according to the added routine.

According to a comparative example, when sharing the routine, portions corresponding to personal information are shared in an empty state and an electronic device receiving the routine requires the user to input corresponding personal information manually before being used. Therefore, when an electronic device receives a shared routine, the portions corresponding to the personal information are shared in the empty state and thus the user receiving the shared routine may have inconvenience to manually input corresponding data.

According to an embodiment of the disclosure, as illustrated in FIGS. 8 and 9, when a routine is shared between electronic devices 810 and 820, the routine may be shared by automatically removing personal information and replacing personal information with hint information. According to an embodiment, the first electronic device 810 may provide routine data in which personal information related to the first electronic device 810 (or a first user of the first electronic device 810) is replaced with hint information and the second electronic device 820 may replace the hint information with personal information related to the second electronic device 820 (or a second user of the second electronic device 820) in the shared routine data. As such, the second electronic device 820 may automatically complete a routine without user involvement and provide the routine when sharing the routine.

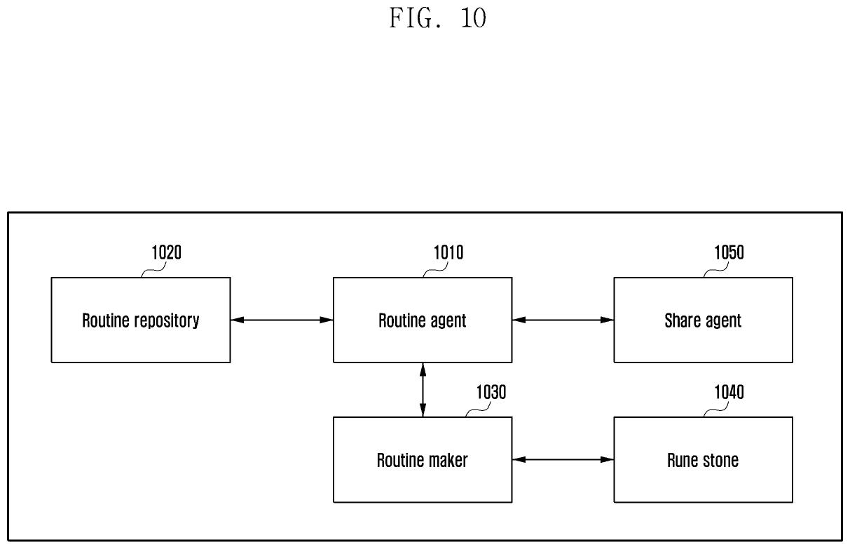

FIG. 10 is a block diagram illustrating an example configuration of an electronic device configured to support a routine-related operation according to various embodiments.

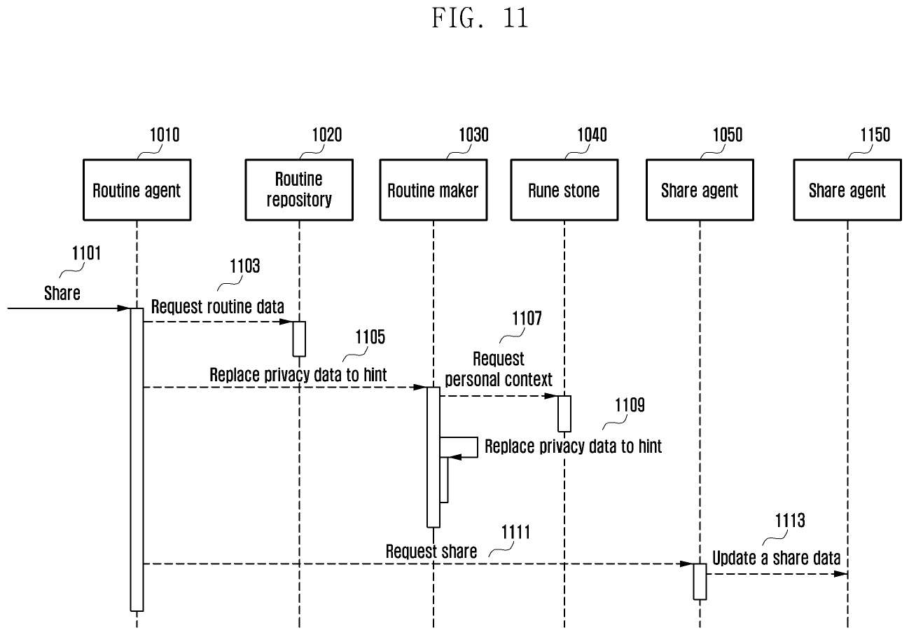

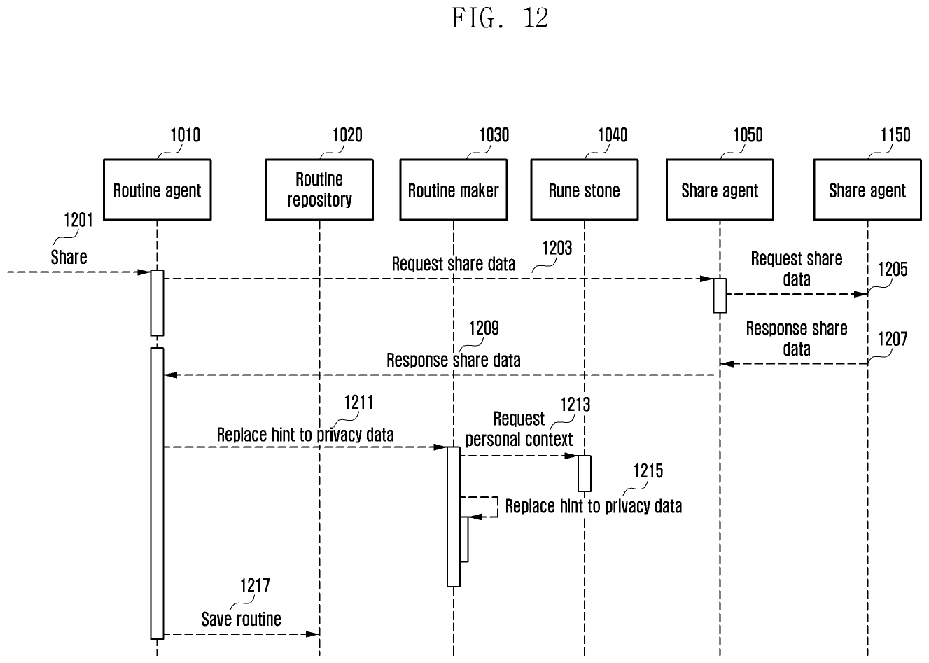

According to an embodiment, FIG. 10 may illustrate an example of a system structure for a routine-related operation in an electronic device 101 (e.g., the first electronic device 810 and the second electronic device 820). According to an embodiment, the electronic device 101 may perform an operation (e.g., the transmission side operation in FIG. 11) of sharing (or transmitting) routine data based on the structure according to an example in FIG. 10 and a routine data reception operation (e.g., the reception side operation in FIG. 12).

Referring to FIG. 10, the electronic device 101 (e.g., the first electronic device 810 and the second electronic device 820) may include a routine agent 1010, a routine repository 1020, a routine maker 1030, a rune stone 1040, and/or a share agent 1050, each of which may include various circuitry and/or executable program instructions.

According to an embodiment, the routine agent 1010 may serve as a routine exporter during the transmission side operation and serve as a routine importer during the reception side operation. According to an embodiment, the routine agent 1010 may retrieve information (e.g., routine data) of a routine to be shared from the routine repository 1020 (or a database) and provide the retrieved routine data to the routine maker 1030. According to an embodiment, the routine agent 1010 may receive the routine data from the share agent 1050 when the routine is received and provide the received routine data to the routine maker 1030. For example, the routine agent 1010 may serve as a bride for performing an operation according to routine sharing or routine reception.

According to an embodiment, the routine repository 1020 may store routine data corresponding to each routine configured in the electronic device 101. According to an embodiment, the routine repository 1020 may correspond to a database configured to database and manage the routine data.

According to an embodiment, the routine maker 1030 may serve to process (e.g., substitution between personal information and hint information) the routine data. According to an embodiment, the routine maker 1030 may, in case that the personal information is present in the routine data transferred from the routine agent 1010 during routine sharing, remove the personal information and generate and add hint information corresponding to the personal information. According to an embodiment, the routine maker 1030 may replace an item of the personal information which has been replaced with the hint information or is empty in the routine data transferred from the routine agent 1010 during routine reception to the personal information of the electronic device 101 (e.g., the second electronic device 820) and generate a routine usable by the electronic device 101.

According to an embodiment, the rune stone 1040 may collect and store a context (or situation information) for the user of the electronic device 101. According to an embodiment, the rune stone 1040 may comprehensively profile and store various information, such as user's demography and/or interest levels for each field. According to an embodiment, contexts (e.g., rune stone context information) collected and stored by the rune stone 1040 may include various information related to a user's behavior, context, and/or preference. For example, the rune stone context information may include time, place, and occasion (TPO) information, state information related to activity time (e.g., work time, study time, exercise time, and/or game time) for each user's activity (e.g., work, study, exercise, and/or game) and whether an activity is performed, a context related to user's various preferences (e.g., a preferred application, a preferred music, a preferred location, a preferred time and/or a preferred device), and/or information related to user's various patterns (e.g., a sleep pattern, an exercise pattern, and/or communication (e.g., Wi-Fi) usage information in a designated location).

According to an embodiment, the share agent 1050 may indicate a system configured to support various a sharing (e.g., transmission or reception) function of various contents in the electronic device 101. For example, the share agent 1050 may correspond to a communication circuit (e.g., the communication module 190 in FIG. 1) configured to support various communication of the electronic device 101. According to an embodiment, the share agent 1050 may transmit the routine data transferred from the routine agent 1010 to another designated electronic device (e.g., the second electronic device 820) during routine sharing. According to an embodiment, the share agent 1050 may receive the routine data from another designated electronic device (e.g., the first electronic device 810) during routine reception, and transfer the received routine data to the routine agent 1010.

FIG. 11 is a signal flow diagram illustrating an example operation of sharing routine data in an electronic device according to various embodiments.

According to an embodiment, FIG. 11 may illustrate an example of an operation in which the electronic device 101 replaces personal information included in routine data with hint information corresponding to the personal information and shares the routine data with another electronic device.

Referring to FIGS. 10 and 11, in operation 1101, the user of the electronic device 101 may perform a user input for sharing a routine of the electronic device 101.

In operation 1103, the routine agent 1010 may determine routine sharing initiation based on a user input and request (e.g., request routine data) routine data of a routine requested to be shared by the user from the routine repository 1020. For example, the routine agent 1010 may retrieve (or acquire) routine data of the routine to be shared by the routine repository 1020.

In operation 1105, the routine agent 1010 may transfer the retrieved routine data to the routine maker 1030 and may request (e.g., replace privacy data to hint) to the personal information (e.g., data) to the hint information (e.g., a hint).

In operation 1107, the routine maker 1030 may request a personal context request (e.g., request personal context) from the rune stone 1040. For example, the routine maker 1030 may acquire, from the rune stone 1040, at least one context related to the personal information of the routine data among various contexts related to user's behavior, context, and/or preference.

In operation 1109, the routine maker 1030 may, based on the context acquired through the rune stone 1040, generate hint information to replace the personal information and replace (e.g., replace privacy data to hint) the personal information with the hint information. According to an embodiment, the routine maker 1030 may generate shared data (e.g., share routine data) in which the personal information has been replaced with the hint information in the routine data, and transfer the shared data to the routine agent 1010. According to an embodiment, the routine maker 1030 may change a condition and/or action in the routine data according to the personal information to the hint information.

In operation 1111, the routine agent 1010 may transfer the shared data in which the personal information is removed and the hint information is added to the share agent 1050 and request a sharing request (e.g., request share) of the shared data.

In operation 1113, the share agent 1050 may transfer the shared data to another designated electronic device through designated communication. According to an embodiment, the share agent 1050 of the electronic device 101 may transfer the shared data to a designated server (e.g., a share agent 1150 of an account-based cloud server) and request (e.g., update shared data) an update based on the shared data.

FIG. 12 is a signal flow diagram illustrating an example operation of configuring a routine based on routine data shared by an electronic device according to various embodiments.

According to an embodiment, FIG. 12 may illustrate an operation of, in case that the electronic device 101 receives a routine (e.g., routine data) from another electronic device, changing hint information of the routine data to personal information and registering the routine as a routine of the electronic device 101.

Referring to FIGS. 10, 11, and 12, in operation 1201, the user of the electronic device 101 may perform a user input for accepting the routine share request.

In operation 1203, the routine agent 1010 may request (e.g., request shared data) the shared data of the routine, which is requested by another electronic device to be shared, from the share agent 1050 based on the user input.

In operation 1205, the share agent 1010 may request shared data request (e.g., request shared data) to a designated server. According to an embodiment, the designated server may store the shared data shared by another electronic device (e.g., the electronic device 101), such as operation 1113 in FIG. 11.

In operation 1207, the share agent 1150 of the server may transmit (e.g., response shared data) the shared data to the share agent 1050 of the electronic device 101, based on that the shared data request of the electronic device 101 is received.

In operation 1209, the share agent 1050 may receive the shared data from the share agent 1150 of the server and transfer (e.g., response shared data) the shared data to the routine agent 1010.

In operation 1211, the routine agent 1010 may transfer the shared data to the routine maker 1030 and request (e.g., replace hint to privacy data) to replace the hint information (e.g., hint) with the personal information (e.g., data).

In operation 1213, the routine maker 1030 may, in case that there is a personal information item which has been replaced with the hint information or is empty in the shared data, request (e.g., request personal context) a personal context from the rune stone 1040. For example, the routine maker 1030 may acquire, from the rune stone 1040, at least one context related to the hint information of the shared data among various contexts related to user's behavior, context, and/or preference.

In operation 1215, the routine maker 1030 may, based on the context acquired through the rune stone 1040, generate personal information to replace the hint information and replace (e.g., replace hint to privacy data) the hint information with the personal information. For example, the routine maker 1030 may generate, from the shared data, routine data immediately usable in the electronic device 101. For example, the routine maker 1030 may perform an operation of filling an item of the personal information which has been replaced with the hint information or is empty in the shared data with a condition and/or action according to the personal information based on the context.

In operation 1217, the routine agent 1010 may transfer the routine data to the routine repository 1020 and store (e.g., save a routine) a routine based on the routine data.

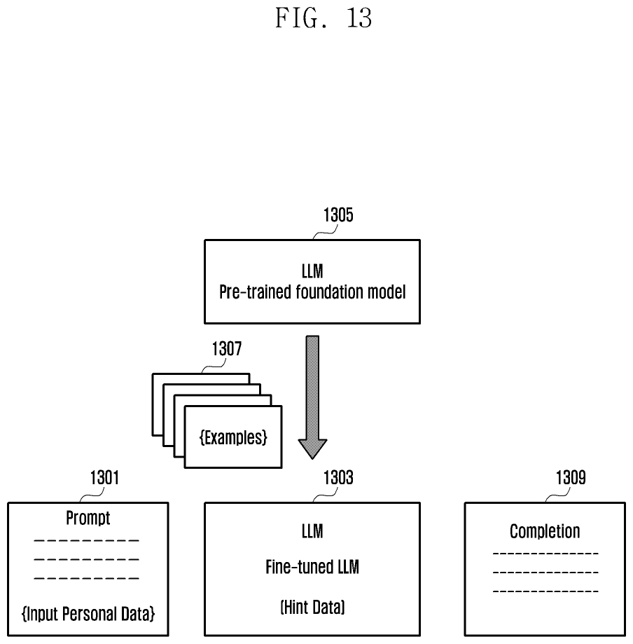

FIG. 13 is a diagram illustrating an example operation of generating personal information-based hint information in an electronic device according to various embodiments.

According to an embodiment, FIG. 13 may illustrate an example of a model in which the electronic device 101 generates personal information with hint information, based on artificial intelligence (e.g., on-device artificial intelligence or generative artificial intelligence).

According to an embodiment, the electronic device 101 may, in case that the routine data (e.g., shared data) requested to be shared includes personal information, generate hint information through the personal information based on a model as shown in FIG. 13 through the routine maker 1030 corresponding to artificial intelligence (e.g., on-device artificial intelligence).

Referring to FIG. 13, the routine maker 1030 may use the personal information as an input (e.g., input personal data) of a prompt 1301. In an embodiment, prompt engineering may refer to a technology of modifying input so that an output matches expectations. According to an embodiment, the routine maker 1030 may provide various examples 1307 of an expected output format, based on a pre-trained foundation model of a large language model (LLM) 1305. In an embodiment, the personal information may be used as a prompt input and an output (e.g., Hint Data) may be generated based on the examples 1307 corresponding to the prompt input. According to an embodiment, in case that the personal information is “a Wi-Fi AP in my room”, the prompt 1301 may be represented as, for example, “a Wi-Fi AP connected from 7 pm on weekdays to the following morning, a location of a terminal at that time is home, and a Wi-Fi AP having a strongest signal among connectible Wi-Fi APs”.

According to an embodiment, the routine maker 1030 may generate an output (e.g., hint data) corresponding to an input using knowledge (e.g., the examples 1307) preserved in the pre-trained foundation model based on a fine-LLM 1303 of the LLM 1305. According to an embodiment, the routine maker 1030 may learn “Hint” and “Personal data” and map an empty space of the shared data shared through the routine with “Hint”. According to an embodiment, the routine maker 1030 may derive “Hint” based on a user's context of the rune stone 1040 and complete 1309 the hint information based on the derived “Hint”.

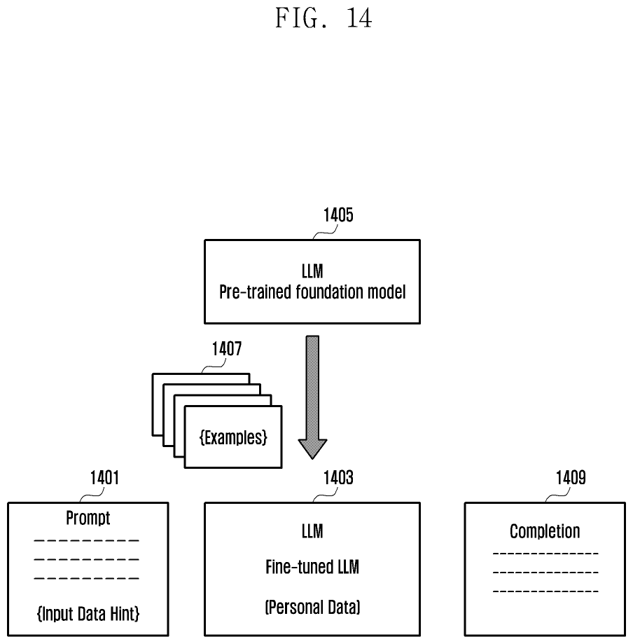

FIG. 14 is a diagram illustrating an example operation of generating hint information-based personal information in an electronic device according to various embodiments.

According to an embodiment, FIG. 14 may illustrate an example of a model in which the electronic device 101 generates hint information with personal information, based on artificial intelligence (e.g., on-device artificial intelligence or generative artificial intelligence) in case that shared data including at least one piece of hint information is received from another electronic device.

According to an embodiment, the electronic device 101 may, in case that the received shared data includes hint information, generate personal information through the hint information based on a model as shown in FIG. 14 through the routine maker 1030 corresponding to artificial intelligence (e.g., on-device artificial intelligence).

Referring to FIG. 14, the routine maker 1040 may use the hint information as an input (e.g., input data Hint) of a prompt 1401. According to an embodiment, the routine maker 1030 may provide various examples 1407 of an expected output format, based on a pre-trained foundation model of a LLM 1405. In an embodiment, the hint information may be used as a prompt input, and an output (e.g., personal Data) may be generated based on the examples 1407 corresponding to the prompt input.

According to an embodiment, the routine maker 1030 may generate an output (e.g., personal data) corresponding to an input using knowledge (e.g., the examples 1407) preserved in the pre-trained foundation model based on a fine-LLM 1403. According to an embodiment, the routine maker 1030 may learn “Hint” and “Personal data” and map an empty space or a hint information item of the shared data shared through the routine with “Personal data”. According to an embodiment, the routine maker 1030 may derive “Personal data” based on a user's context of the rune stone 1040 and complete 1409 the personal information based on the derived “Personal data”. For example, the routine maker 1030 may fill an empty item or a hint information item of the shared data with the personal information of the electronic device 101 so as to complete an immediately available routine.

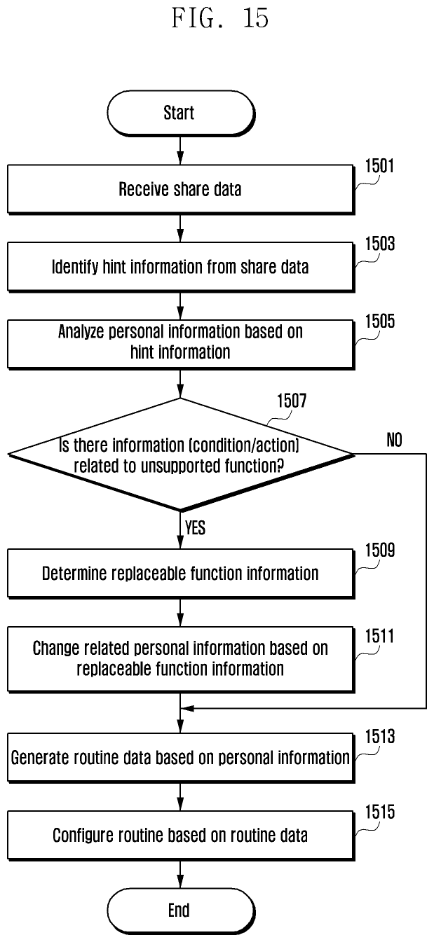

FIG. 15 is a flowchart illustrating an example method of operating an electronic device according to various embodiments.

According to an embodiment, FIG. 15 may illustrate an example of an operation of supporting a routine configuration operation configured to configure a routine shared (or received) from another electronic device (e.g., the first electronic device 810) as a routine of the electronic device 101 in the electronic device 101 (e.g., the second electronic device 820) based on artificial intelligence.

An operation supported in the electronic device 101 according to an embodiment of the disclosure may be performed according to the flowchart shown in FIG. 15, for example. The flowchart shown in FIG. 15 is merely an example according to an embodiment of the operation of the electronic device 101, and at least some operations may be changed in the order thereof, performed in parallel, or performed as independent operations, or at least some other operations may be performed complementary to at least some operations. According to an embodiment, operations 1501 to 1515 may be performed by at least one processor (e.g., the processor 120 or 214 in FIG. 1, 2, or 4) of the electronic device 101.

According to an embodiment, operations shown in FIG. 15 may be combined with the operations shown in FIG. 5 or 6 to be performed heuristically, may be replaced in terms of at least some of the described operations and combined with at least some other operations to be performed heuristically, or may be performed heuristically as detailed operations of at least some operations of the described operations.

As shown in FIG. 15, a method performed by the electronic device 101 according to an embodiment may include an operation 1501 of receiving shared data, an operation 1503 of identifying hint information from information of the shared data, an operation 1505 of analyzing personal information based on the hint information, an operation 1507 of identifying whether there is information related to an unsupported function, an operation 1513 of, in case that there is no information related to an unsupported function, generating routine data based on the personal information, an operation 1509 of, in case that there is information related to an unsupported function, determining replaceable function information, an operation 1511 of changing related personal information based on the replaceable function information, an operation 1513 of generating routine data based on the personal information, and an operation 1515 of configuring a routine based on the routine data.

Referring to FIG. 15, in operation 1501, the processor 120 of the electronic device 101 may receive shared data. According to an embodiment, the processor 120 may receive shared data which is transferred from another electronic device connected through direct or wireless communication to the electronic device 101.

In operation 1503, the processor 120 may identify hint information from information of shared data. According to an embodiment, the processor 120 may determine (or extract) the hint information related to the personal information in the routine data from an analysis result of the routine data.

In operation 1505, the processor 120 may analyze the personal information based on the hint information. According to an embodiment, the processor 120 may determine feature data (or a feature word) from the hint information through artificial intelligence. According to an embodiment, the processor 120 may perform linguistic context analysis from feature data (e.g., feature word) through artificial intelligence. In an embodiment, the linguistic context analysis may include, for example, analysis in consideration of the context surrounding an essence of personal information (e.g., feature data). According to an embodiment, the processor 120 may determine personal information (e.g., personal information analysis), which may replace (or correspond to) the hint information.

According to an embodiment, the processor 120 may analyze a designated condition and/or action, based on linguistic context analysis from the feature data. According to an embodiment, the processor 120 may determine personal information for the electronic device 101 from the hint information through artificial intelligence and map a condition and/or action corresponding to the personal information (e.g., personal information mapping), based on a determination result.

In operation 1507, the processor 120 may perform an operation of identifying whether there is information related to an unsupported function. According to an embodiment, the processor 120 may determine whether there is personal information (e.g., a condition and/or action) of which a related function is not supported (or provided) by the electronic device 101, from the shared data.

According to an embodiment, the routine data of the first electronic device 810 and the routine data of the second electronic device 820 may not provide a partial function depending on a platform of each electronic device. According to an embodiment, the first electronic device 810 and the second electronic device 820 may have different platforms. For example, a partial condition and/or action of the routine data may be included in the first electronic device 810 but not included in the second electronic device 820. According to an embodiment, the routine “Turn on the TV when arrived home” may be configured in the first electronic device 810. According to an embodiment, it may be assumed that the TV controlled by the first electronic device 810 is an “AAA” model and there is no TV controllable by the second electronic device 820. For example, the first electronic device 810 and the second electronic device 820 may have different control target electronic devices. Accordingly, another action may be performed in response to “Turn on the TV” in the electronic device 820 and it may be necessary to regenerate the corresponding action based on the personal information of the second electronic device 820.

In operation 1507, in case that there is no unsupported function (e.g., “No” in operation 1507), the processor 120 may proceed to operation 1513 and perform operations following operation 1513.

In operation 1507, in case that there is an unsupported function (e.g., “Yes” in operation 1507), the processor 120 may proceed to operation 1509 and determine replaceable function information. According to an embodiment, the processor 120 may determine function information which may replace (or is similar to) the personal information of the unsupported function, based on various contexts. According to an embodiment, in case that there is no action for function information (e.g., “Turn on the TV” configured in the first electronic device 810) derived from the hint information, the processor 120 may cause the user of the electronic device 101 (e.g., the second electronic device 820) to search function information (e.g., another electronic device (or replaceable device) frequently used by the user) (e.g., a smart speaker or smart light bulb) which may perform a function corresponding to “Turn on the TV”.

In operation 1511, the processor 120 may perform an operation of changing the related personal information based on replaceable function information. According to an embodiment, the processor 120 may replace the personal information of the unsupported function with function information of a similar function to change corresponding personal information. For example, the processor 120 may perform mapping by changing a condition and/or action of the corresponding personal information to a condition and/or action corresponding to the function information. According to an embodiment, the processor 120 may map operation control of another searched electronic device to an action. According to an embodiment, the processor 120 may cause the user to identify the action change, based on a designated notification (e.g., a visual and/or auditory notification) with respect to the action change.

In operation 1513, the processor 120 may perform an operation of generating routine data based on the personal information. According to an embodiment, the processor 120 may reconfigure shared data and generate routine data including personal information instead of hint information.

In operation 1515, the processor 120 may perform an operation of configuring a routine based on the routine data. According to an embodiment, the processor 120 may configure a routine of the electronic device 101, using the generated routine data. According to an embodiment, the processor 120 may execute the routine by automatically executing a designated action when a designated condition is satisfied, based on the routine configuration.

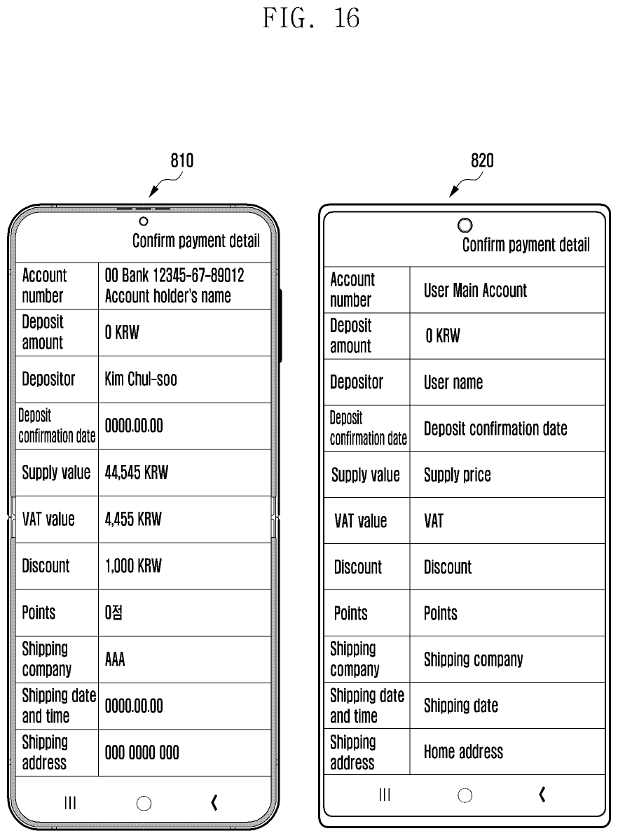

In an embodiment of the disclosure, for convenience of explanation, the description is given of an example in which routine data is shared among electronic devices by cross-referencing and changing personal information and hint information within the routine data based on routine sharing, but the disclosure is not limited thereto. For example, according to an embodiment of the disclosure, in addition to the routine sharing, in case that there is personal information in various data (e.g., shared data) sharable among electronic devices, the personal information in the shared data may be replaced with the hint information and then provided, or the hint information in the received shared data may be replaced with the personal information and then provided. An example thereof is illustrated in FIG. 16.

FIG. 16 is a diagram illustrating an example operation of providing a routine-related operation in an electronic device according to various embodiments.

According to an embodiment, FIG. 16 may illustrate an example in which personal information is replaced with hint information and provided in case that a template (e.g., shared data) includes personal information when the template for automatic input of information (e.g., product purchase information) is shared as shared data in a designated service (e.g., purchase information service or shopping mall service). For example, the first user may share the shared data (e.g., a template) or the first electronic device 810 with the second electronic device 820 of the second user as purchase information. According to an embodiment, in case that the first user purchases a product from a shopping mall and then share related information with the second user, as shown in FIG. 16, various personal information may be included and the first electronic device 810 may replace the personal information with corresponding hint information and share the information.

Referring to FIG. 16, the template of the first electronic device 810 may include personal information related to the first user (e.g., information related to the first user input to an account field, deposit field, deposit confirmation date field, . . . , and/or delivery address field). According to an embodiment, in case that the template is shared with the second electronic device 820, the first electronic device 810 may replace personal information of a field related to the personal information in the template with corresponding hint information (e.g., replacement information, such as a user main account, a user name, a deposit confirmation data, . . . , and/or a home address) and provide the template including the hint information to the second electronic device 820 as the shared data.

According to an embodiment, in case that the shared data (e.g., the template) is received from the first electronic device 810, as shown in FIG. 16, the second electronic device 820 may replace the hint information of the field related with the personal information with corresponding personal information (e.g., information related to the second user of the second electronic device 820) and input personal information related to the second user to the field related to the personal information and provide same. For example, the second electronic device 820 may provide the template acquired through conversion to the personal information of the second user to the second user.

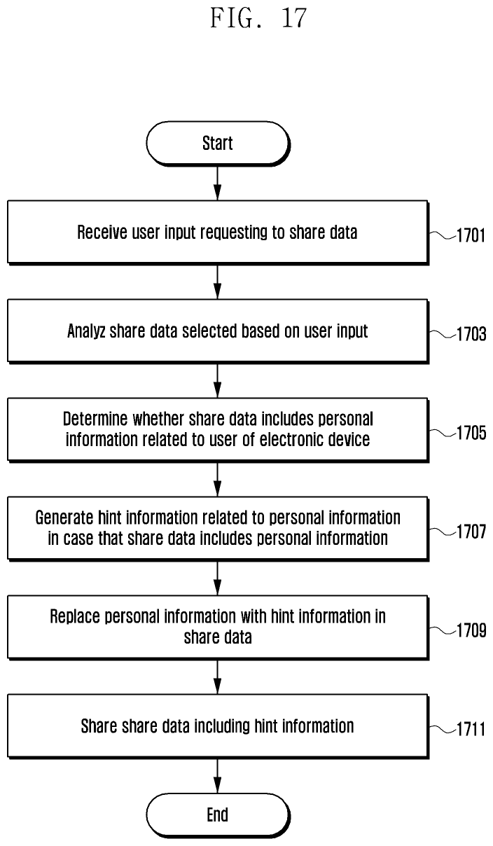

FIG. 17 is a flowchart illustrating an example method of operating an electronic device according to various embodiments.

According to an embodiment, FIG. 17 may illustrate an example of an operation in which the electronic device 101 shares data of the electronic device 101 with another electronic device, based on artificial intelligence.

An operation supported in the electronic device 101 according to an embodiment of the disclosure may be performed according to the flowchart shown in FIG. 17, for example. The flowchart shown in FIG. 17 is merely an example according to an embodiment of the operation of the electronic device 101, and at least some operations may be changed in the order thereof, performed in parallel, or performed as independent operations, or at least some other operations may be performed complementary to at least some operations. According to an embodiment, operations 1701 to 1711 may be performed by at least one processor (e.g., the processor 120 or 214 in FIG. 1, 2, or 4) of the electronic device 101.

According to an embodiment, operations shown in FIG. 17 may be combined with the operations shown in FIGS. 5 to 6, and/or 15 to be performed heuristically, may be replaced in terms of at least some of the described operations and combined with at least some other operations to be performed heuristically, or may be performed heuristically as detailed operations of at least some operations of the described operations.

As shown in FIG. 17, operations performed by the electronic device 101 according to an embodiment may include an operation 1701 of receiving a user input to request to share data of the electronic device, an operation 1703 of analyzing shared data selected based on a user input requesting sharing data of the electronic device 101, an operation 1705 of determining whether the shared data includes personal information related to the user of the electronic device 101, an operation 1707 of, in case that the shared data includes the personal information, generating hint information related to the personal information so that information corresponding to the personal information may be inferred by another electronic device (e.g., an external electronic device), an operation 1709 of replacing the personal information with the hint information in the shared data, and an operation 1711 of sharing the shared data including the hint information.

Referring to FIG. 17, in operation 1701, the processor 120 of the electronic device 101 may receive a user input to request sharing of data of the electronic device 101.

In operation 1703, the processor 120 may perform an operation of analyzing shared data selected based on the user input.

In operation 1705, the processor 120 may perform an operation of determining whether the shared data includes personal information related to the user of the electronic device 101.

In operation 1707, the processor 120 may perform an operation of, in case that the shared data includes the personal information, generating hint information related to the personal information so that information corresponding to the personal information may be inferred by another electronic device.

In operation 1709, the processor 120 may perform an operation of replacing the personal information with the hint information in the shared data.

In operation 1711, the processor 120 may perform an operation of sharing the shared data including the hint information.

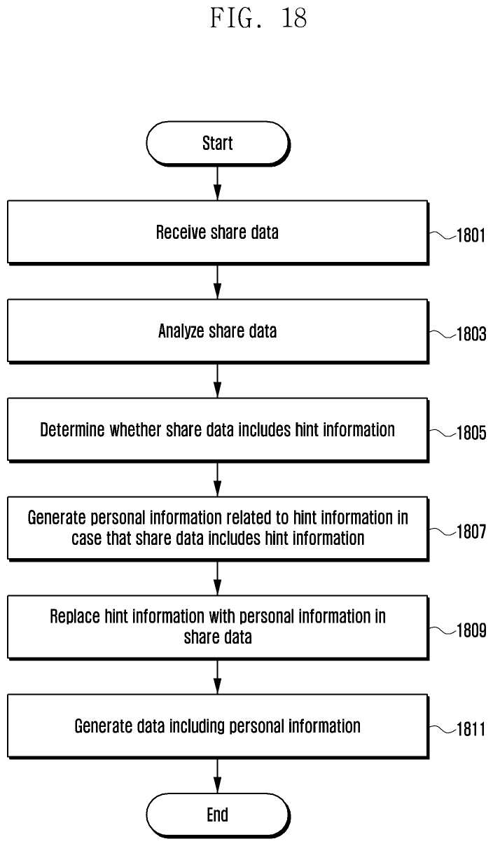

FIG. 18 is a flowchart illustrating an example method of operating an electronic device according to an embodiment of the disclosure.

According to an embodiment, FIG. 18 may illustrate an example of an operation in which the electronic device 101 changes personal information based on hint information of shared data received from another electronic device to generate data of the electronic device 101 based on artificial intelligence.

An operation supported in the electronic device 101 according to an embodiment of the disclosure may be performed according to the flowchart shown in FIG. 18, for example. The flowchart shown in FIG. 18 is merely an example according to an embodiment of the operation of the electronic device 101, and at least some operations may be changed in the order thereof, performed in parallel, or performed as independent operations, or at least some other operations may be performed complementary to at least some operations. According to an embodiment, operations 1801 to 1811 may be performed by at least one processor (e.g., the processor 120 or 214 in FIG. 1, 2, or 4) of the electronic device 101.

According to an embodiment, operations shown in FIG. 18 may be combined with the operations shown in FIGS. 5 to 6, 15, and/or 17 to be performed heuristically, may be replaced in terms of at least some of the described operations and combined with at least some other operations to be performed heuristically, or may be performed heuristically as detailed operations of at least some operations of the described operations.

As shown in FIG. 18, the method performed by the electronic device 101 according to an embodiment may include an operation 1801 of receiving shared data, an operation 1803 of analyzing the shared data, an operation 1805 of determining whether the shared data includes hint information, an operation 1807 of, in case that the shared data includes hint information, generating personal information related to the hint information, an operation 1809 of replacing the hint information with the personal information in the shared data, and an operation 1811 of generating data including the personal information.

Referring to FIG. 18, in operation 1801, the processor 120 of the electronic device 101 may receive shared data.

In operation 1803, the processor 120 may perform an operation of analyzing the shared data.

In operation 1805, the processor 120 may perform an operation of determining whether the shared data includes personal information.

In operation 1807, the processor 120 may perform an operation of, in case that the shared data includes the hint information, generating personal information related to the hint information.

In operation 1809, the processor 120 may perform an operation of replacing the hint information with the personal information in the shared data.

In operation 1811, the processor 120 may perform an operation of generating data including the personal information.

A method performed by an electronic device according to an example embodiment of the disclosure may include: receiving an input to request to share data of the electronic device; analyzing shared data selected based on the input; determining whether the shared data includes personal information related to the user of the electronic device; based on the shared data including the personal information, generating hint information related to the personal information so that information corresponding to the personal information may be inferred by an external electronic device; replacing the personal information with the hint information in the shared data; and sharing the shared data including the hint information.

According to an example embodiment, the generating the hint information may include: determining feature data from the personal information and generating the hint information having a specified linguistic context, based on the linguistic context analysis, from feature data.

According to an example embodiment, the replacing may include: removing the personal information from the shared data and adding hint information, which has replaced the personal information, to the shared data and reconfiguring the shared data.

According to an example embodiment, the method may include: receiving shared data from an external electronic device; analyzing the shared data; determining whether the shared data includes hint information; based on the shared data including the hint information, generating personal information related to the hint information; replacing the hint information with the personal information in the shared data; and generating data including the personal information.

According to an example embodiment, the method may include: determining the hint information from at least one piece of information of the shared data and changing an item corresponding to the hint information to personal information related to the user of the electronic device in the shared data.

According to an example embodiment, the generating the personal information may include: determining feature data from the hint information and analyzing a context of the hint information from the feature data, based on linguistic context analysis.

According to an example embodiment, the method may include: determining whether there is a function not supported by the electronic device, based on the hint information, based on there being an unsupported function, determining replaceable function information and personal information of the unsupported function, based on the hint information, and changing the personal information of the unsupported function, based on the replaceable function information.

A non-transitory computer-readable recording medium may store instructions, when executed by at least one processor, comprising processing circuitry, individually and/or collectively of an electronic device according to an example embodiment of the disclosure, causes the electronic device to perform operations, including: receiving an input requesting sharing data of an electronic device, analyzing shared data selected based on the input, determining whether the shared data includes personal information related to a user of the electronic device, based on the shared data including the personal information, generating hint information related to the personal information so that information corresponding to the personal information may be inferred by an external electronic device, replacing the personal information with the hint information in the shared data, and sharing the shared data including the hint information.

It should be understood that the aforementioned embodiments and technical features thereof may potentially be combined with each other in each and every combination, as long as there is no conflict between the various embodiments or features. For example, any combination of two or more of the aforementioned embodiments may be conceived and included within the scope of the disclosure. One or more features from any embodiment may be integrated into any other embodiment, providing the corresponding advantages or benefits.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The various example embodiments illustrated and described in the disclosure and the drawings are merely examples that have been presented to easily explain the technical contents of the disclosure and aid in understanding, and are not intended to limit the scope of the disclosure. Therefore, the scope of the disclosure should be understood to include, in addition to the various example embodiments set forth herein, all changes and modifications derived based on the technical idea of the disclosure, including the appended claims and their equivalents.

What is claimed is:

1. An electronic device comprising:
a display;
memory storing instructions; and
at least one processor comprising a processing circuitry,
wherein at least one processor, individually and/or collectively, is configured to execute the instructions and to cause the electronic device to:
receive an input requesting to share data of the electronic device;
analyze shared data selected based on the input;
determine whether the shared data comprises personal information related to a user of the electronic device;
based on the shared data comprising the personal information, generate hint information related to the personal information so that information corresponding to the personal information is inferable by an external electronic device;
replace the personal information with the hint information in the shared data; and
share the shared data comprising the hint information.

2. The electronic device of claim 1, wherein at least one processor, individually and/or collectively, is configured to cause the electronic device to determine the personal information from at least one piece of information of the shared data.

3. The electronic device of claim 1, wherein at least one processor, individually and/or collectively, is configured to cause the electronic device to:
determine feature data from the personal information; and
analyze a context of the personal information from the feature data, based on linguistic context analysis.

4. The electronic device of claim 1, wherein at least one processor, individually and/or collectively, is configured to cause the electronic device to generate hint information having a specific linguistic context from the feature data of the personal information, based on linguistic context analysis.

5. The electronic device of claim 1, wherein at least one processor, individually and/or collectively, is configured to cause the electronic device to:
remove the personal information from the shared data; and
add hint information, which has replaced the personal information, to the shared data and reconfigure the shared data.

6. The electronic device of claim 1, wherein at least one processor, individually and/or collectively, is configured to cause the electronic device to transmit the shared data to an external electronic device connected through designated communication to share the shared data of the electronic device with the external electronic device.

7. The electronic device of claim 1, wherein at least one processor, individually and/or collectively, is configured to cause the electronic device to:
receive shared data from an external electronic device;
analyze the shared data;
determine whether the shared data comprises hint information;
based on the shared data comprising the hint information, generate personal information related to the hint information;
replace the hint information with the personal information in the shared data; and
generate data comprising the personal information.

8. The electronic device of claim 7, wherein at least one processor, individually and/or collectively, is configured to cause the electronic device to determine the hint information from at least one piece of information of the shared data.

9. The electronic device of claim 7, wherein at least one processor, individually and/or collectively, is configured to cause the electronic device to change an item corresponding to the hint information to personal information related to the user of the electronic device in the shared data.

10. The electronic device of claim 7, wherein at least one processor, individually and/or collectively, is configured to cause the electronic device to:
determine feature data from the hint information; and
analyze a context of the hint information from the feature data, based on linguistic context analysis.

11. The electronic device of claim 7, wherein at least one processor, individually and/or collectively, is configured to cause the electronic device to determine whether there is a function not supported by the electronic device, based on the hint information.

12. The electronic device of claim 11, wherein at least one processor, individually and/or collectively, is configured to cause the electronic device to:
based on there being an unsupported function, determine replaceable function information and personal information of the unsupported function, based on the hint information; and
change the personal information of the unsupported function, based on the replaceable function information.

13. The electronic device of claim 7, wherein at least one processor, individually and/or collectively, is configured to cause the electronic device to store the data but not the shared data.

14. A method of operating an electronic device, the method comprising:
receiving an input requesting to share data of the electronic device;
analyzing shared data selected based on the input;
determining whether the shared data comprises personal information related to a user of the electronic device;
based on the shared data comprising the personal information, generating hint information related to the personal information so that information corresponding to the personal information is inferable by an external electronic device;
replacing the personal information with the hint information in the shared data; and
sharing the shared data comprising the hint information.

15. The method of claim 14, wherein the generating of the hint information comprises:
determining feature data from the personal information; and
generating hint information having a specific linguistic context from the feature data, based on linguistic context analysis.

16. The method of claim 14, wherein the replacing comprises:
removing the personal information from the shared data; and
adding hint information, which has replaced the personal information, to the shared data and reconfiguring the shared data.

17. The method of claim 14, further comprising:
receiving shared data from an external electronic device;
analyzing the shared data;
determining whether the shared data comprises hint information;
based on the shared data comprising the hint information, generating personal information related to the hint information;
replacing the hint information with the personal information in the shared data; and
generating data comprising the personal information.

18. The method of claim 17, comprising:
determining the hint information from at least one piece of information of the shared data;
determining feature data from the hint information;
analyzing a context of the hint information from the feature data, based on linguistic context analysis; and
changing an item corresponding to the hint information to personal information related to the user of the electronic device in the shared data.

19. The method of claim 17, comprising:
determining whether there is a function not supported by the electronic device, based on the hint information.
based on there being an unsupported function, determining replaceable function information and personal information of the unsupported function, based on the hint information; and
changing the personal information of the unsupported function, based on the replaceable function information.

20. A non-transitory computer-readable recording medium configured to store instructions which, when executed by at least one processor, comprising processing circuitry, individually and/or collectively, of an electronic device, causes the electronic device to perform operations comprising:
receiving an input requesting to share data of the electronic device;
analyzing shared data selected based on the input;
determining whether the shared data comprises personal information related to a user of the electronic device;
based on the shared data comprising the personal information, generating hint information related to the personal information so that information corresponding to the personal information is inferable by an external electronic device;
replacing the personal information with the hint information in the shared data; and
sharing the shared data comprising the hint information.
